(19) United States
(12) Patent Application Publication
(10) Pub. No.: US 2025/0158646 A1
(43) Pub. Date: May 15, 2025

(54) BALANCED AMPLIFIERS FOR REDUCED PARASITIC INTERACTION BETWEEN ANTENNA ELEMENTS IN PHASED ARRAY MILLIMETER-WAVE TRANSMITTERS

(71) Applicant: Skyworks Solutions, Inc., Irvine, CA (US)

(72) Inventor: David Richard Pehlke, Westlake Village, CA (US)

(21) Appl. No.: 18/946,450

(22) Filed: Nov. 13, 2024

Related U.S. Application Data
(60) Provisional application No. 63/548,496, filed on Nov. 14, 2023.

(51) Int. Cl. H04B 1/04; H04B 1/10; H04B 1/16

(52) U.S. Cl. CPC H04B 1/0475; H04B 1/1036; H04B 1/1607

(57) ABSTRACT

A radio frequency front end system with an antenna system including a first antenna. A transmit and receive system includes at least a first transmit and receive module having a transmit unit transmits a first radio frequency transmission signal to the at least one first antenna. A receive unit receives a first radio frequency reception signal from the at least one first antenna. A parasitic signal removal unit removes a second radio frequency reception signal received at the at least one first antenna and back-injected into the transmit unit of the first transmit and receive module.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

Embodiments of the invention relate to electronic systems, and in particular, to radio frequency (RF) electronics supporting concurrent reception and transmission over a plurality of bands, such as Evolved-Universal Terrestrial Radio Access (E-UTRA) New Radio (NR) dual connectivity (EN-DC), carrier aggregation (CA), and/or multi-input and multi-output (MIMO) in 5G & millimeter wave technology. In particular, embodiments of the present invention relate to enabling 4×4 downlink (DL) MIMO for the frequency band b46.

### Description of the Related Technology

RF communication systems can be used for transmitting and/or receiving signals of a wide range of frequencies. For example, a RF communication system can be used to wirelessly communicate RF signals in a frequency range of about 30 kHz to 300 GHz, such as in the range of about 450 MHz to about 7.125 GHz for certain communications standards, e.g., Fifth Generation (5G) cellular communications.

Examples of RF communication devices include, but are not limited to, mobile phones, tablets, base stations, network access points, customer-premises equipment (CPE), laptops, and wearable electronics.

### SUMMARY OF CERTAIN INVENTIVE CONCEPTS

The systems, methods and devices of this disclosure each have several aspects, no single one of which is solely responsible for the desirable attributes disclosed herein.

In certain applications, RF communications systems/mobile wireless devices can be simultaneously and/or multiply connected to one or more networks of the same and/or of different generations and at same, similar, or different bands and transmit and/or receive a plurality of RF signals simultaneously. RF front-ends (RFFEs) are used for RF signal reception (Rx) and transmission (Tx). Where Rx and Tx are concurrently on, high levels of isolation are required, for instance to reduce intermodulation distortion (IMD).

Furthermore, dependent on which frequency band is used for wireless communications, the mobile devices use an antenna system typically consisting of several sets of antenna units for different bands. One or more of the antenna units can be used for the respective frequency band in order to conduct 4×4 DL MIMO exhibiting in particular highly efficient downlink reception at high data rates.

A typical transmit and receive module of a radio frequency (RF) front end, RFFE system for uplink/downlink transmission typically comprises an antenna module including a plurality of antennas and a transceiver module including a plurality of transceivers each connected to a respective antenna through a respective coupler. Each transceiver has a transmit (Tx) unit (transmit path) configured to transmit RF transmission signals to the respective antenna through a respective RF coupler and a receive (Rx) unit (receive path) configured to receive RF reception signals from the respective antenna through the RF coupler. The plurality of antennas and the plurality of transceivers are necessary because the RFFE system is required to transmit/receive RF signals in a plurality of different frequency bands, e.g. in the n77, n79 or b46 frequency bands. Bandpass filters to separate signals can be used in the transmit/receive path of the transceivers to filter out transmission/reception signals in the frequency band at which the respective transceiver is to operate. This is a possible technique to avoid that stray/parasitic transmission signals in a second frequency band transmitted from an adjacent second transceiver are back-injected into the transmit path (or receive path depending on the switching of the RF coupler) of a first transceiver operating in a different frequency band. However, if the second transceiver operates in the same frequency band as the first transceiver, parasitic transmission signals transmitted from the antenna of the second transceiver may indeed enter the transmit path (ore receive path) of the first transceiver through the respective antenna of the first transceiver. This is a particular problem in 2×2 uplink or 4×4 MIMO uplink transmission because due the space restrictions in the terminal in which the RFFE system is used, transceivers are closely arranged to each other and transmit RF signals at the same frequency (and possibly with different phase) to a phased array Mm wave antenna. Hence, if the first transceiver is transmitting RF signals on its transmit path to the antenna on a predetermined RF frequency, parasitic signals of the same frequency transmitted from a transmit path and an antenna of a closely arranged second transceiver transmitting on the same frequency may indeed enter (are back-injected into) the transmit path of the first transceiver and corrupt or at least impair the transmission of the transmission signal of the first transceiver. Since both transceivers transmit on the same predetermined frequency, band pass filters cannot be used to remove these parasitic signals of the same frequency from the transmit path of the first transceiver.

In more, detail, 5G technologies include transmission of very high frequency radio signals to enable use of large available spectral bandwidths, and beam forming in small form factors to direct more dedicated resources to individual users and drastically increase data rates and reduce power consumption per bit. Phased array transmitters/transceivers are used to form these beams for uplink (UL) and downlink (DL) and rely on multiple antenna elements driven at varying amplitude and phase to construct coherent phase front transmission in a specific narrowed direction, with the benefits of antenna gain and less splatter of wasted energy in undesired directions.

These phased arrays and the multiple active antenna elements must be calibrated in order to establish just the right amount of amplitude and phase from each antenna element in order to precisely position and adjust the beam-quite a challenge in the small amount of available volume of a modern smartphone. Multiple arrays are typically placed in the handset in order to avoid blockage or limited scan angle/directionality from any one array, and the precise beam direction and adjustment is at the core of establishing a high performance link—the more narrow the beam, the more sensitive impairments and off-angle errors become.

One of the most common uplink, UL, impairments in the electrically small implementations required in the handset is the unexpected deviation from expected amplitude and phase that any one individual antenna element transmission suffers due to interference and finite isolation by use of the bandpass filters from the other neighboring antenna elements. The back-injected signal of nearby antenna elements can cause clipping and/or reverse intermodulation due to the finite nonlinearities of the power amplifier, which is challenged to become more nonlinear as efficiency requirements increase. The transmitter non-linearity can be corrected for forward nonlinearity using wide bandwidth DPD techniques. DPD stands for Digital Pre-Distortion which is a technique used in mobile communications to improve the linearity of power amplifiers (PAs) in transmitters.

However, in particular in phased array MmWave transmitters, there is another phenomenon in power amplifiers which cannot easily be corrected which is IMD which stands for Intermodulation Distortion. IMD is a phenomenon that occurs in mobile communications when two or more signals interact with each other in a non-linear system, such as a power amplifier (PA). Hence, Intermodulation Distortion (IMD) is the generation of unwanted frequencies due to the mixing of two or more signals. However, reverse IMD and post-PA antenna coupling issues are not correctable even with DPD. In addition, complex, time-consuming, and expensive calibrations are required wherein it is required that individual transmission from each antenna element remain as consistent as possible independent of the afore mentioned variability due to neighbor elements, because the sensitivity and performance as a function of amplitude/phase/modulation/etc. from each of the neighbor elements would become prohibitive to test for and correct using predictive models for the behavior.

Hence, the present invention aims at reducing parasitic interaction between antenna elements in particular in phased array MmWave transmitters.

For this purpose, a radio frequency (RF) front end (RFFE) system comprises an antenna system including at least one first antenna, and a transmit and receive (TR) system including at least a first transmit and receive (TR) module having a transmit (Tx) unit configured to transmit a first RF transmission signal to the at least one first antenna, a receive (Rx) unit configured to receive a first RF reception signal from the at least one first antenna and a parasitic signal removal unit configured to remove a second RF reception signal received at the at least one first antenna and back-injected into the Tx unit of the first TR module.

According to an embodiment, the Tx unit may include a first output terminal, a second output terminal, and an input terminal, the first output terminal being connected to the at least one first antenna and the input terminal adapted to receive a to be transmitted signal.

According to an embodiment, the parasitic signal removal unit may be arranged in the Tx unit of the first TR module and include a first phase conversion unit configured to convert the second RF reception signal into a third RF reception signal and a fourth RF reception signal. The first phase conversion unit may be configured to generate as the third RF reception signal the second RF reception signal with a phase 180° shifted from that of the second RF reception signal, and to generate as the fourth RF reception signal the second RF reception signal with a phase 90° shifted from that of the second RF reception signal.

According to an embodiment, the Tx unit of the first transceiver may include a second phase conversion unit configured to 90° phase shift the to be transmitted signal received at the input terminal, a first Tx path and a second Tx path, the first Tx path including a first transmit amplifier unit configured to amplify the to be transmitted signal, and the second Tx path including a second transmit amplifier unit configured to amplify the 90° phase shifted to be transmitted signal.

According to an embodiment, the first phase conversion unit may be formed by a first input terminal of a first 90° hybrid coupler connected to an output of the first transmit amplifier unit, a second input terminal thereof connected to an output of the second transmit amplifier unit, a first 0° output terminal thereof connected to the second output terminal, and a second 90° output terminal thereof connected to the first output terminal. In this manner, the first 90° hybrid coupler generates the third 180° shifted RF reception signal at its second output terminal along with a 0° version of the second RF reception signal by the second RF reception signal having travelled through the first hybrid coupler backwards, being reflected at the amplifier unit outputs, and travelling forwards again through the first 90° coupler.

According to an embodiment, the second phase conversion unit may be formed by a second 90° hybrid coupler having an input terminal connected to the input terminal of the Tx unit, a first 0° output terminal connected to an input of the first transmit amplifier unit, and a second 90° output terminal connected to an input of the second transmit amplifier unit. Such a use of balanced amplifiers can reduce or completely remove parasitic interaction between antenna elements in particular in phased array MmWave transmitters.

90° hybrid couplers, for example 90° baluns using distributed Lange coupler structures, are readily achievable at the higher frequencies of the mmWave transmitter, which are smaller and easier to implement in high performance for large relative % bandwidth and low loss. Additional aspects can leverage Doherty amplification efficiency advantage by replacing each branch PA (first and second transmit amplifier unit) with a dual Doherty implementation within a balanced architecture—for significant efficiency advantages of larger peak to average waveform support and fixed supply voltage (average power tracking=APT) Tx architectures.

In some aspects, the techniques described herein relate to a radio frequency front end system, including: an antenna system including at least one first antenna; and a transmit and receive system including at least a first transmit and receive module having a transmit unit configured to transmit a first radio frequency transmission signal to the at least one first antenna, a receive unit configured to receive a first radio frequency reception signal from the at least one first antenna and a parasitic signal removal unit configured to remove a second radio frequency reception signal received at the at least one first antenna and back-injected into the transmit unit of the first transmit and receive module.

In some aspects, the techniques described herein relate to a radio frequency front end system wherein the transmit unit includes a first output terminal, a second output terminal, and an input terminal, the first output terminal being connected to the at least one first antenna and the input terminal adapted to receive a to be transmitted signal.

In some aspects, the techniques described herein relate to a radio frequency front end system wherein the parasitic signal removal unit is arranged in the transmit unit of the first transmit and receive module and includes a first phase conversion unit configured to convert the second radio frequency reception signal into a third radio frequency reception signal and a fourth radio frequency reception signal.

In some aspects, the techniques described herein relate to a radio frequency front end system wherein the first phase conversion unit is configured to output as the third radio frequency reception signal the second radio frequency reception signal with a phase 180° shifted from that of the second radio frequency reception signal, and to output as the fourth radio frequency reception signal the second radio frequency reception signal with a phase 90° shifted from that of the second radio frequency reception signal.

In some aspects, the techniques described herein relate to a radio frequency front end system wherein the parasitic signal removal unit is configured to output the second radio frequency reception signal and the third radio frequency reception signal to the first output terminal of the transmit unit of the first transmit and receive module, the second and third radio frequency signals cancelling each other at the first output terminal.

In some aspects, the techniques described herein relate to a radio frequency front end system wherein the parasitic signal removal unit is further configured to output the fourth radio frequency reception signal to the second output terminal of the transmit unit of the first transmit and receive module.

In some aspects, the techniques described herein relate to a radio frequency front end system wherein the second output terminal of the transmit unit of the first transmit and receive module is connected to ground.

In some aspects, the techniques described herein relate to a radio frequency front end system further including a resistor connected between the second output terminal of the transmit unit of the first transmit and receive module and ground.

In some aspects, the techniques described herein relate to a radio frequency front end system wherein the first transmit and receive module further includes a transmit/receive switch having a first, second and third switch terminal, the first switch terminal being connected to the first antenna, the second switch terminal being connected to the first output terminal of the transmit unit, and the third switch terminal being connected to the receive unit of the first transmit and receive module.

In some aspects, the techniques described herein relate to a radio frequency front end system wherein the transmit unit of the first transmit and receive module further includes a second phase conversion unit configured to 90° phase shift the to be transmitted signal received at the input terminal, a first transmit path and a second transmit path, the first transmit path including a first transmit amplifier unit configured to amplify the to be transmitted signal, and the second transmit path including a second transmit amplifier unit configured to amplify the 90° phase shifted to be transmitted signal.

In some aspects, the techniques described herein relate to a radio frequency front end system wherein the first phase conversion unit is formed by a first input terminal of a first 90° hybrid coupler connected to an output of the first transmit amplifier unit, a second input terminal thereof connected to an output of the second transmit amplifier unit, a first 0° output terminal thereof connected to the second output terminal, and a second 90° output terminal thereof connected to the first output terminal.

In some aspects, the techniques described herein relate to a radio frequency front end system wherein the second phase conversion unit is formed by a second 90° hybrid coupler having an input terminal connected to the input terminal of the transmit unit, a first 0° output terminal connected to an input of the first transmit amplifier unit, and a second 90° output terminal connected to an input of the second transmit amplifier unit.

In some aspects, the techniques described herein relate to a radio frequency front end system wherein the receive unit includes an receive path having a receive amplifier.

In some aspects, the techniques described herein relate to a radio frequency front end system wherein the first transmit amplifier unit and the second transmit amplifier unit are power amplifiers.

In some aspects, the techniques described herein relate to a radio frequency front end system wherein the power amplifiers form a Doherty power amplifier.

In some aspects, the techniques described herein relate to a radio frequency front end system wherein the receive amplifier is a low noise amplifier.

In some aspects, the techniques described herein relate to a radio frequency front end system wherein the antenna system further includes a second antenna and the transmit and receive system further includes a second transmit and receive module, the second transmit and receive module including a transmit unit configured to transmit the second radio frequency transmission signal to the second antenna and a receive unit configured to receive radio frequency reception signals from the second antenna, the second antenna configured to transmit the second radio frequency transmission signal to the first antenna.

In some aspects, the techniques described herein relate to a radio frequency front end system wherein the antenna system includes a phased array antenna.

In some aspects, the techniques described herein relate to a radio frequency front end system, including: an antenna system including at least one first antenna; and a transmit and receive system including at least a first transmit and receive module having a transmit unit including a first output terminal being connected to the at least one first antenna, a second output terminal connected to ground, and an input terminal adapted to receive a to be transmitted signal, a first 90° hybrid coupler, two transmit amplifier units, and a second hybrid 90° coupler, a first input terminal of the first 90° hybrid coupler connected to an output of the first transmit amplifier unit, a second input terminal thereof connected to an output of the second transmit amplifier unit, a first 0° output terminal thereof connected to the second output terminal, and a second 90° output terminal thereof connected to the first output terminal, and the second 90° hybrid coupler having an input terminal connected to the input terminal of the transmit unit, a first 0° output terminal connected to an input of the first transmit amplifier unit, and a second 90° output terminal connected to an input of the second transmit amplifier unit.

In some aspects, the techniques described herein relate to a radio frequency front end system wherein the first transmit and receive module includes a resistor connected between the second output terminal of the transmit unit of the first module and ground.

In some aspects, the techniques described herein relate to a radio frequency front end system wherein the first transmit and receive module further includes a transmit/receive switch having a first, second and third switch terminal, the first switch terminal being connected to the at least one first antenna, the second switch terminal being connected to the first output terminal of the transmit unit, and the third switch terminal being connected to the receive unit of the first transmit and receive module.

In some aspects, the techniques described herein relate to a radio frequency front end system wherein the receive unit includes an receive path, the receive path including a receive amplifier.

In some aspects, the techniques described herein relate to a radio frequency front end system wherein the first and second transmit amplifier are power amplifiers.

In some aspects, the techniques described herein relate to a radio frequency front end system wherein the power amplifiers form a Doherty power amplifier.

In some aspects, the techniques described herein relate to a radio frequency front end system wherein the receive amplifier is constituted by a low noise amplifier.

In some aspects, the techniques described herein relate to a radio frequency front end system wherein the antenna system further includes a second antenna and the transmit and receive system further includes a second transmit and receive module, the second transmit and receive module includes a transmit unit configured to transmit radio frequency transmission signals to the second antenna, and the second antenna is coupled to the first antenna.

In some aspects, the techniques described herein relate to a radio frequency front end system wherein the antenna system includes a phased array antenna.

In some aspects, the techniques described herein relate to a balanced amplifier architecture for a phased array MmWave transmitter, including: a first transmit path including a first transmit amplifier unit; a second transmit path including a second transmit amplifier unit; a first hybrid 90° balun coupler connected to the first transmit path; a second hybrid 90° balun coupler connected to the second transmit path; an isolation port connected to a termination resistor configured to dump undesired signals; and a desired balun output configured to provide phase coherence and cancelling reverse intermodulation distortion (RIMD).

In some aspects, the techniques described herein relate to a balanced amplifier architecture wherein the second hybrid 90° balun coupler, the transmit amplifier units, and the first 90° hybrid coupler are connected in this order between an input and an output of the balanced amplifier architecture.

In some aspects, the techniques described herein relate to a balanced amplifier architecture connected to an antenna module, the antenna module including a phased array antenna.

In some aspects, the techniques described herein relate to a method for removing parasitic signals in a radio frequency front end system including an antenna module including at least a first and second antenna, and a transmit and receive system module including at least a first transmit and receive module having a transmit unit and a second transmit and receive module, the method including: transmitting, by the transmit unit of the first transmit and receive module, a first radio frequency transmission signal to the first antenna; transmitting, by the second transmit and receive module, a second radio frequency transmission signal to the second antenna, the second radio frequency transmission signal being at least partially coupled from the second antenna to the first antenna and being back-injected into the transmit unit of the first transmit and receive module; and removing, in the transmit unit of the first transmit and receive module, the second radio frequency reception signal received at the first antenna and back-injected into the transmit unit of the first transmit and receive module.

In some aspects, the techniques described herein relate to a method, further including outputting, by the transmit unit of the first transmit and receive module, radio frequency signals at a first output terminal and second output terminal, and receiving at an input terminal a to be transmitted signal.

In some aspects, the techniques described herein relate to a method, further including a converting step, carried out by a first phase conversion unit of the transmit unit of the first transmit and receive module, of converting the second radio frequency reception signal into a third radio frequency reception signal and a fourth radio frequency reception signal.

In some aspects, the techniques described herein relate to a method, the first phase conversion unit outputting as the third radio frequency reception signal the second radio frequency reception signal with a phase 180° shifted from that of the second radio frequency reception signal, and outputting as the fourth radio frequency reception signal the second radio frequency reception signal with a phase 90° shifted from that of the second radio frequency reception signal.

In some aspects, the techniques described herein relate to a method, the parasitic signal removal unit outputting the second radio frequency reception signal and the third radio frequency reception signal to the first output terminal of the transmit unit of the first transmit and receive module, the second and third radio frequency signals cancelling each other at the first output terminal.

In some aspects, the techniques described herein relate to a method, the parasitic signal removal unit outputting the fourth radio frequency reception signal to the second output terminal of the transmit unit of the first transmit and receive module.

In some aspects, the techniques described herein relate to a method, further including a 90° phase shifting step, carried out by a second phase conversion unit in the transmit unit of the first transmit and receive module, of 90° phase shifting the to be transmitted signal received at the input terminal, amplifying, by a first transmit amplifier unit in the transmit path of the first transmit and receive module, the to be transmitted signal, and amplifying, by a second transmit amplifier unit in the transmit path of the first transmit and receive module, the 90° phase shifted to be transmitted signal.

In some aspects, the techniques described herein relate to a method, the converting step being carried out by a first 90° hybrid coupler connected to an output of the transmit amplifier units.

In some aspects, the techniques described herein relate to a method, the 90° phase shifting step being carried out by a second 90° hybrid coupler connected to the inputs of the transmit amplifier units.

In some aspects, the techniques described herein relate to a method for removing parasitic signals in a radio frequency front end system including an antenna system including at least a first antenna and a second antenna, and a transmit and receive system including at least a first transmit and receive module having a transmit unit and a second transmit and receive module, the method including: transmitting, by the second transmit and receive module, an radio frequency signal to the second antenna, the radio frequency signal being at least partially coupled from the second antenna to the first antenna and being back-injected into the transmit unit of the first transmit and receive module; and removing, in the transmit unit of the first transmit and receive module the radio frequency signal received at the first antenna and back-injected into the transmit unit of the first transmit and receive module; the removing including: a first generating step of generating a 180° shifted version of the back-injected radio frequency signal and combining the back-injected radio frequency signal and a 180° shifted version thereof at a first output terminal of the first transmit and receive module connected to the first antenna; and a second generating step of generating a first 90° shifted version of the back-injected signal and a second 90° shifted version of the back-injected signal and combining them at a second output terminal of the first transmit and receive module.

In some aspects, the techniques described herein relate to a method, further including: receiving, at an input terminal of the transmit unit of the first transmit and receive module, a to be transmitted signal; 90° phase shifting, by a second 90° hybrid coupler in the transmit unit of the first transmit and receive module, the to be transmitted signal to generate a first 90° phase shifted to be transmitted signal; amplifying, by a first and second transmit amplifier unit in the transmit unit of the first transceiver coupled to the outputs of the second 90° hybrid coupler, the to be transmitted signal and the first 90° phase shifted to be transmitted signal to generate a first amplified to be transmitted signal and a first amplified 90° phase shifted to be transmitted signal; 90° phase shifting, by a first 90° hybrid coupler in the transmit unit of the first transmit and receive module coupled to the outputs of the first and second transmit amplifier units, the first amplified to be transmitted signal to generate a second amplified 90° phase shifted to be transmitted signal; and combining the first amplified 90° phase shifted to be transmitted signal and the second amplified 90° phase shifted to be transmitted signal at the first output terminal of the first transmit and receive module.

In some aspects, the techniques described herein relate to a method, the first generating step and the second generating step being carried out by a combination of the first 90° hybrid coupler and the first and second transmit amplifier units coupled to the inputs of the first 90° hybrid coupler, by: transmitting the back-injected signal backwards through the first 90° hybrid coupler; reflecting a 90° phase shifted version of the backwards transmitted back-injected signal at the output of the first transmit amplifier unit; reflecting the backwards transmitted back-injected signal at the output of the second transmit amplifier unit; transmitting the reflected 90° phase shifted version of the backwards transmitted back-injected signal and a 90° phase shifted version of the reflected backward-injected signal forwards through the first 90° hybrid coupler to the second output terminal; and transmitting a 90° phase shifted version of the reflected 90° phase shifted version of the backwards transmitted back-injected signal and the reflected backward-injected signal forwards through the first 90° hybrid coupler to the first output terminal.

In some aspects, the techniques described herein relate to a method for reducing parasitic interaction between antenna elements in a phased array MmWave transmitter, including the steps of: transmitting a parasitic radio frequency signal from a second antenna element to a first antenna element of the phased array antenna; generating a 180° phase shifted version of the parasitic radio frequency signal; combining the parasitic radio frequency signal and its 180° phase shifted version at a first output terminal of the transmitter; generating two 90° phase shifted versions of the parasitic radio frequency signal; and combining the two 90° phase shifted versions of the parasitic radio frequency signal at a second output terminal of the transmitter.

In some aspects, the techniques described herein relate to a packaged module including: a die; surface mount components; wirebonds; a package substrate; and an encapsulation structure; the package substrate including pads formed from conductors disposed therein; the die further including pads; the wirebonds electrically connecting the pads of the die to the pads of the package substrate; and the die including a radio frequency front end system including a an antenna system including at least one first antenna and a transmit and receive system including at least a first transmit and receive module having a transmit unit configured to transmit a first radio frequency transmission signal to the at least one first antenna, a receive unit configured to receive a first radio frequency reception signal from the at least one first antenna and a parasitic signal removal unit configured to remove a second radio frequency reception signal received at the at least one first antenna and back-injected into the transmit unit of the first transmit and receive module.

In some aspects, the techniques described herein relate to a packaged module including: a die; surface mount components; wirebonds; a package substrate; and an encapsulation structure; the package substrate including pads formed from conductors disposed therein; the die further including pads; the wirebonds electrically connecting the pads of the die to the pads of the package substrate; and the die including a radio frequency front end system including an antenna system including at least one first antenna and a transmit and receive system including at least a first transmit and receive module having a transmit unit including a first output terminal being connected to the at least one first antenna, a second output terminal connected to ground, and an input terminal adapted to receive a to be transmitted signal, a first 90° hybrid coupler, two transmit amplifier units, and a second hybrid 90° coupler, a first input terminal of the first 90° hybrid coupler connected to an output of the first transmit amplifier unit, a second input terminal thereof connected to an output of the second transmit amplifier unit, a first 0° output terminal thereof connected to the second output terminal, and a second 90° output terminal thereof connected to the first output terminal, and the second 90° hybrid coupler having an input terminal connected to the input terminal of the transmit unit, a first 0° output terminal connected to an input of the first transmit amplifier unit, and a second 90° output terminal connected to an input of the second transmit amplifier unit.

In some aspects, the techniques described herein relate to a packaged module including: a die; surface mount components; wirebonds; a package substrate; and an encapsulation structure; the package substrate including pads formed from conductors disposed therein; the die further including pads; the wirebonds electrically connecting the pads of the die to the pads of the package substrate; and the die including a balanced amplifier architecture for a phased array MmWave transmitter including a first transmit path including a first transmit amplifier unit, a second transmit path including a second transmit amplifier unit, a first hybrid 90° balun coupler connected to the first transmit path, a second hybrid 90° balun coupler connected to the second transmit path, an isolation port connected to a termination resistor configured to dump undesired signals; and a desired balun output configured to provide phase coherence and cancelling reverse intermodulation distortion (RIMD).

In some aspects, the techniques described herein relate to a phone board, including the packaged module.

In some aspects, the techniques described herein relate to a phone board, including the packaged module.

In some aspects, the techniques described herein relate to a phone board, including the packaged module.

### BRIEF DESCRIPTION OF THE DRAWINGS

FIG. 1 is a diagram of an example dual connectivity network topology.

FIG. 2 is a schematic diagram of one example of a communication network.

FIG. 2A is a schematic diagram of one example of a communication link using carrier aggregation.

FIG. 2B illustrates various examples of carrier aggregation for the communication link of FIG. 2A.

FIG. 3A is a schematic diagram of one example of a downlink channel using multi-input and multi-output (MIMO) communications.

FIG. 3B is schematic diagram of one example of an uplink channel using MIMO communications.

FIG. 4A is a schematic diagram of an exemplary radio frequency (RF) system.

FIG. 4B is a schematic diagram of an exemplary RF system.

FIG. 4C is a schematic diagram of an exemplary RF system.

FIG. 5 is a schematic diagram of an exemplary RF system.

FIG. 6 is a schematic diagram of an exemplary RF system.

FIG. 7A is a schematic diagram of an exemplary ultrahigh band (UHB) transmit and receive module.

FIG. 7B is a schematic diagram of an exemplary high band (HB) transmit and receive module.

FIG. 7C is a schematic diagram of an exemplary mid band (MB) transmit and receive module.

FIG. 7D is a schematic diagram of an exemplary 2G power amplifier module according.

FIG. 7E is a schematic diagram of an exemplary uplink carrier aggregation and MIMO module.

FIG. 7F is an overview of frequency bands used for different purposes in wireless mobile communications;

FIG. 7G is a block diagram of a typical radio frequency, RF, front end, RFFE system, including a radio frequency, RF, front and, RFFE coupled to an antenna system ASY;

FIG. 7H is a block diagram showing more details of the RFFE system depicted in FIG. 7G;

FIG. 7I is an example of a two receiver units RU1, RU2 coupled to a first antenna unit AU1, and in particular, a typical design of with a first and second receiver unit RU-1, RU 2-1; RU 1-2, RU 2-2 for corresponding receive and transmit paths Tx1, Rx1 and Tx2, Rx2;

FIG. 7J is a more detailed block diagram of a typical Near Side UE and Far Side UE (user equipment) in which a plurality of receiver units for different bands as in FIG. 7H are coupled to a number of antennas ANT1-ANT6 for providing reception/transmission in the frequency bands illustrated in FIG. 7F, and in particular the usage of two receiver units RU1, RU2 for the n77 and n79 frequency bands and two receiver units RU3, RU4 for a typical b46 2×2 downlink-MIMO reception;

FIG. 7K is a block diagram similar to that in FIG. 7J which shows the usage of four receiver units RU1 to RU4 for realizing a full b46 band 4×4 downlink-MIMO according to an embodiment;

FIG. 7L is a more detailed block diagram of the receiver units RU1 to RU4 of FIG. 7K using amplifiers and filters, as well as switches for realizing the b46 4×4 downlink MIMO and in particular the connection to four antenna units AU1 to AU4;

FIG. 7M is a flowchart of a method according to an embodiment;

FIG. 7N is another flowchart of a method in accordance with another embodiment;

FIG. 7O is another flowchart of a method according to another embodiment;

FIG. 7P is another flowchart of a method according to another embodiment;

FIG. 7Q is another flowchart of a method in accordance with an embodiment, in particular for carrying out the reception steps for the b46 4×4 downlink-MIMO as shown in FIG. 7L

FIG. 8A shows an example of an RFFES system including an antenna system ASY and a transmit and receive (TR) system TRS according to an embodiment;

FIG. 8B illustrates parasitic signal coupling between two transmit and receive (TR) modules TRM1, TRM2;

FIG. 8C illustrates parasitic signal coupling in an RFFES system including a plurality n of transmit and receive (TR) modules TRM1, TRM2, TRM3 . . . . TRMn;

FIG. 8D illustrates a transmit and receive (TR) module TRM and signal generation using a parasitic signal removal unit PSR according to an embodiment

FIG. 8E illustrates a parasitic signal removal unit PSR including a first phase conversion unit PCU1 and a corresponding signal generation according to an embodiment;

FIG. 8F illustrates the effects and the signal generation of the first phase conversion unit PCU1 when an additional reflection unit RF is used in the TX unit TXU1 in FIG. 8E according to an embodiment;

FIG. 8G illustrates the parasitic signal flow using a first 90° hybrid coupler HYB1 as the first phase conversion unit PCU1 according to an embodiment;

FIG. 8H illustrates the transmission signal flow using the 90° hybrid coupler HYB1 as the first phase conversion unit PCU1 according to an embodiment;

FIG. 8I illustrates the parasitic signal flow when one input terminal HB12 of the 90° hybrid coupler HYB1 is connected to ground according to an embodiment;

FIG. 8J illustrates the transmission signal flow using a second phase conversion unit PCU2 at the input terminal HB12 of the first 90° hybrid coupler HYB1 according to an embodiment;

FIG. 8K illustrates the parasitic signal flow in a balanced amplifier Tx unit using a first and a second 90° hybrid coupler HYB1, HYB2;

FIG. 8L illustrates the signal flow of the transmission signal in the balanced amplifier Tx unit;

FIG. 8M illustrates a transmission and reception (TR) module TRM with balanced amplifiers according to FIG. 8K included in a transmit and receive (TR) module TRM according to an embodiment;

FIG. 8N illustrates a RFFES system shown in FIG. 8C but using transmit and receive (TR) modules according to FIG. 8M;

FIG. 9A is a schematic diagram of an exemplary packaged module.

FIG. 9B is a schematic diagram of a cross-section of the exemplary packaged module of FIG. 9A taken along the lines 9B-9B.

FIG. 10 is a schematic diagram of an exemplary mobile device.

### DETAILED DESCRIPTION OF EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IoT), Vehicle-to-Everything (V2X), and High Power User Equipment (HPUE).

3GPP introduced Phase 1 of fifth generation (5G) technology in Release 15, and developed 5G technology further in Release 16. Subsequent 3GPP releases will further evolve and expand 5G technology. 5G technology is also referred to herein as 5G New Radio (NR).

Preliminary specifications for 5G NR support a variety of features, such as communications over millimeter wave spectrum, beam forming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

### Dual Connectivity

With the introduction of the 5G NR air interface standards, 3GPP has allowed for the simultaneous operation of 5G and 4G standards in order to facilitate the transition. This mode can be referred to as Non-Stand-Alone (NSA) 5G operation or E-UTRAN New Radio-Dual Connectivity (EN-DC) and involves both 4G and 5G carriers being simultaneously transmitted from a user equipment (UE).

In certain EN-DC applications, dual connectivity NSA involves overlaying 5G systems onto an existing 4G core network. For dual connectivity in such applications, the control and synchronization between the base station and the UE can be performed by the 4G network while the 5G network is a complementary radio access network tethered to the 4G anchor. The 4G anchor can connect to the existing 4G network with the overlay of 5G data/control.

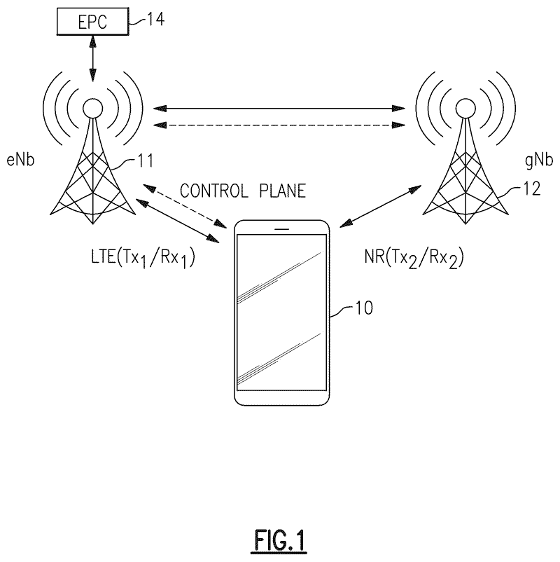

FIG. 1 is a diagram of an example dual connectivity network topology. This architecture can leverage LTE legacy coverage to ensure continuity of service delivery and the progressive rollout of 5G cells. A UE 10 can simultaneously transmit dual uplink LTE and NR carrier. The UE 10 can transmit an uplink LTE carrier Tx1 to the eNB 11 while transmitting an uplink NR carrier Tx2 to the gNB 12 to implement dual connectivity. Any suitable combination of uplink carriers Tx1, Tx2 and/or downlink carriers Rx1, Rx2 can be concurrently transmitted via wireless links in the example network topology of FIG. 1. The eNB 11 can provide a connection with a core network, such as an Evolved Packet Core (EPC) 14. The gNB 12 can communicate with the core network via the eNB 11. Control plane data can be wireless communicated between the UE 10 and eNB 11. The eNB 11 can also communicate control plane data with the gNB 12. Control plane data can propagate along the paths of the dashed lines in FIG. 1. The solid lines in FIG. 1 are for data plane paths.

In the example dual connectivity topology of FIG. 1, any suitable combinations of standardized bands and radio access technologies (e.g., FDD, TDD, SUL, SDL) can be wirelessly transmitted and received. This can present technical challenges related to having multiple separate radios and bands functioning in the UE 10. With a TDD LTE anchor point, network operation may be synchronous, in which case the operating modes can be constrained to Tx1/Tx2 and Rx1/Rx2, or asynchronous which can involve Tx1/Tx2, Tx1/Rx2, Rx1/Tx2, Rx1/Rx2. When the LTE anchor is a frequency division duplex (FDD) carrier, the TDD/FDD inter-band operation can involve simultaneous Tx1/Rx1/Tx2 and Tx1/Rx1/Rx2.

As discussed above, EN-DC can involve both 4G and 5G carriers being simultaneously transmitted from a UE. This disclosure provides systems and methods of supporting EN-DC/NSA operation for concurrent UL transmission of both 4G (LTE anchor) and 5G signals, most often defined for inter-band dual connectivity and a kind of UL carrier aggregation

Architectures to support this require additional RF paths that support concurrent transmission. RF paths that are close enough in frequency (within what is termed a “band group” i.e. LB, MB, HB, UHB, etc.) are supported on a single trace to an antennaplexer (that further merges signals on bands with larger frequency offsets). Such bands on shared traces often need to be either ganged (i.e. trimmed or equilibrated to match each other) or switch-combined through a switch to be able to combine the signals onto that common trace. When this is the case, concurrent UL signals within that band group are problematic because full power UL signals will be on common trace and create large intermodulation products that then often fall into the active Rx victim channels and cause large Rx desensitization. In order to support concurrency on the maximum number of antennas and avoid or eliminate the IMD degradations, duplicated Tx RF paths are designed into the architecture with sufficient carrier aggregation support across all band combinations. This advantageously allows for being able to transmit on separate antennas with sufficient RF isolation to address the IMD and Rx impairments.

EN-DC is one application/architecture where the concept of the present invention works well. However, the concept is more generally applicable, not just for EN-DC modules.

### Communication Network

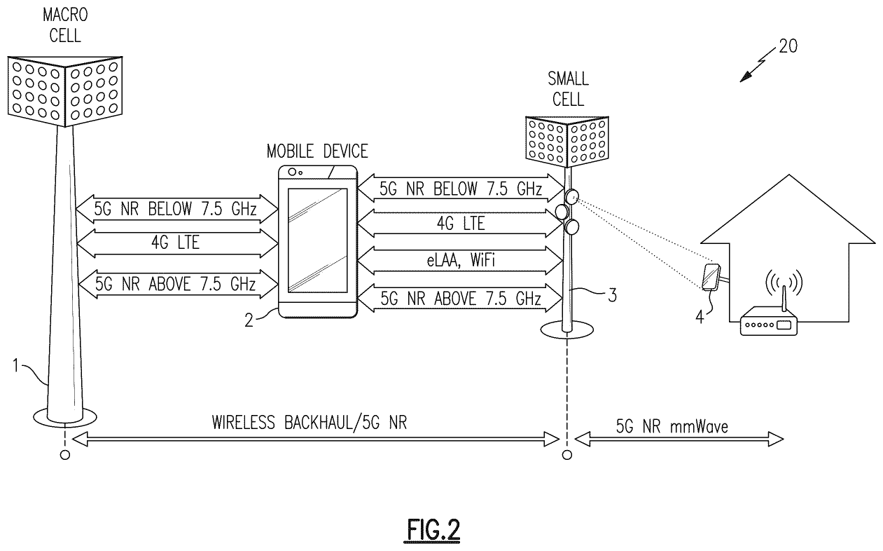

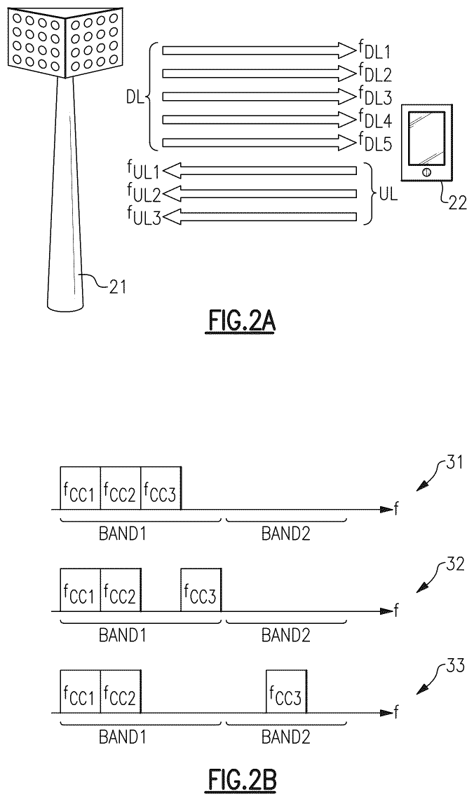

FIG. 2 is a schematic diagram of one example of a communication network 20. The communication network 20 includes a macro cell base station 1, a mobile device 2, a small cell base station 3, and a stationary wireless device 4.

The illustrated communication network 20 of FIG. 2 supports communications using a variety of technologies, including, for example, 4G LTE, 5G NR, and wireless local area network (WLAN), such as Wi-Fi. In the communication network 20, dual connectivity can be implemented with concurrent 4G LTE and 5G NR communication with the mobile device 2. Although various examples of supported communication technologies are shown, the communication network 20 can be adapted to support a wide variety of communication technologies.

Various communication links of the communication network 20 have been depicted in FIG. 2. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

As shown in FIG. 2, the mobile device 2 communicates with the macro cell base station 1 over a communication link that uses a combination of 4G LTE and 5G NR technologies. The mobile device 2 also communications with the small cell base station 3. In the illustrated example, the mobile device 2 and small cell base station 3 communicate over a communication link that uses 5G NR, 4G LTE, and Wi-Fi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed Wi-Fi frequencies).

In certain implementations, the mobile device 2 communicates with the macro cell base station 2 and the small cell base station 3 using 5G NR technology over one or more frequency bands that are less than 7.5 Gigahertz (GHz) and/or over one or more frequency bands that are greater than 7.5 GHz. For example, wireless communications can utilize Frequency Range 1 (FR1), Frequency Range 2 (FR2), or a combination thereof. In one embodiment, the mobile device 2 supports a HPUE power class specification.

The illustrated small cell base station 3 also communicates with a stationary wireless device 4. The small cell base station 3 can be used, for example, to provide broadband service using 5G NR technology. In certain implementations, the small cell base station 3 communicates with the stationary wireless device 4 over one or more millimeter wave frequency bands in the frequency range of 30 GHz to 300 GHz and/or upper centimeter wave frequency bands in the frequency range of 24 GHz to 30 GHz.

In certain implementations, the small cell base station 3 communicates with the stationary wireless device 4 using beamforming. For example, beamforming can be used to focus signal strength to overcome path losses, such as high loss associated with communicating over millimeter wave frequencies.

The communication network 20 of FIG. 2 includes the macro cell base station 1 and the small cell base station 3. In certain implementations, the small cell base station 3 can operate with relatively lower power, shorter range, and/or with fewer concurrent users relative to the macro cell base station 1. The small cell base station 3 can also be referred to as a femtocell, a picocell, or a microcell.

Although the communication network 20 is illustrated as including two base stations, the communication network 20 can be implemented to include more or fewer base stations and/or base stations of other types. As shown in FIG. 2, base stations can communicate with one another using wireless communications to provide a wireless backhaul. Additionally or alternatively, base stations can communicate with one another using wired and/or optical links.

The communication network 20 of FIG. 2 is illustrated as including one mobile device and one stationary wireless device. The mobile device 2 and the stationary wireless device 4 illustrate two examples of user devices or user equipment (UE). Although the communication network 20 is illustrated as including two user devices, the communication network 20 can be used to communicate with more or fewer user devices and/or user devices of other types. For example, user devices can include mobile phones, tablets, laptops, Internet of Things (IoT) devices, wearable electronics, and/or a wide variety of other communications devices.

User devices of the communication network 20 can share available network resources (for instance, available frequency spectrum) in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user device a unique code, space-divisional multiple access (SDMA) in which beamforming is used to provide shared access by spatial division, and non-orthogonal multiple access (NOMA) in which the power domain is used for multiple access. For example, NOMA can be used to serve multiple user devices at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user device. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with IoT applications.

The communication network 20 of FIG. 2 can be used to support a wide variety of advanced communication features, including, but not limited to eMBB, uRLLC, and/or mMTC.

A peak data rate of a communication link (for instance, between a base station and a user device) depends on a variety of factors. For example, peak data rate can be affected by channel bandwidth, modulation order, a number of component carriers, and/or a number of antennas used for communications.

For instance, in certain implementations, a data rate of a communication link can be about equal to M*B*log₂(1+S/N), where M is the number of communication channels, B is the channel bandwidth, and S/N is the signal-to-noise ratio (SNR).

Accordingly, data rate of a communication link can be increased by increasing the number of communication channels (for instance, transmitting and receiving using multiple antennas), using wider bandwidth (for instance, by aggregating carriers), and/or improving SNR (for instance, by increasing transmit power and/or improving receiver sensitivity).

5G NR communication systems can employ a wide variety of techniques for enhancing data rate and/or communication performance.

### Carrier Aggregation

FIG. 2A is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations.

In the illustrated example, the communication link is provided between a base station 21 and a mobile device 22. As shown in FIG. 2A, the communications link includes a downlink channel used for RF communications from the base station 21 to the mobile device 22, and an uplink channel used for RF communications from the mobile device 22 to the base station 21.

Although FIG. 2A illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link. Carrier aggregation includes contiguous aggregation, in which contiguous carriers within the same operating frequency band are aggregated. Carrier aggregation can also be non-contiguous, and can include carriers separated in frequency within a common band or in different bands.

In the example shown in FIG. 2A, the uplink channel includes three aggregated component carriers fUL1, fUL2, and fUL3. Additionally, the downlink channel includes five aggregated component carriers fDL1, fDL2, fDL3, fDL4, and fDL5. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

FIG. 2B illustrates various examples of carrier aggregation for the communication link of FIG. 2A. FIG. 2B includes a first carrier aggregation scenario 31, a second carrier aggregation scenario 32, and a third carrier aggregation scenario 33, which schematically depict three types of carrier aggregation.

The carrier aggregation scenarios 31-33 illustrate different spectrum allocations for a first component carrier fcc1, a second component carrier fcc2, and a third component carrier fcc3. Although FIG. 2B is illustrated in the context of aggregating three component carriers, carrier aggregation can be used to aggregate more or fewer carriers.

The first carrier aggregation scenario 31 illustrates intra-band contiguous carrier aggregation, in which component carriers that are adjacent in frequency and in a common frequency band are aggregated. For example, the first carrier aggregation scenario 31 depicts aggregation of component carriers fcc1, fcc2, and fcc3 that are contiguous and located within a first frequency band BAND1.

With continuing reference to FIG. 2B, the second carrier aggregation scenario 32 illustrates intra-band non-continuous carrier aggregation, in which two or more components carriers that are non-adjacent in frequency and within a common frequency band are aggregated. For example, the second carrier aggregation scenario 32 depicts aggregation of component carriers fcc1, fcc2, and fcc3 that are non-contiguous, but located within a first frequency band BAND1.

The third carrier aggregation scenario 33 illustrates inter-band non-contiguous carrier aggregation, in which component carriers that are non-adjacent in frequency and in multiple frequency bands are aggregated. For example, the third carrier aggregation scenario 33 depicts aggregation of component carriers fcc1 and fcc2 of a first frequency band BAND1 with component carrier fcc3 of a second frequency band BAND2.

With reference to FIGS. 2A and 2B, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, when the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using a SCC. The primary and second cells may have different coverage areas, for instance, due to differences in frequencies of carriers and/or network environment.

License assisted access (LAA) refers to downlink carrier aggregation in which a licensed frequency carrier associated with a mobile operator is aggregated with a frequency carrier in unlicensed spectrum, such as Wi-Fi. LAA employs a downlink PCC in the licensed spectrum that carries control and signaling information associated with the communication link, while unlicensed spectrum is aggregated for wider downlink bandwidth when available. LAA can operate with dynamic adjustment of secondary carriers to avoid Wi-Fi users and/or to coexist with Wi-Fi users. Enhanced license assisted access (eLAA) refers to an evolution of LAA that aggregates licensed and unlicensed spectrum for both downlink and uplink.

Carrier aggregation (CA) is one application/architecture where the concept of the present invention works well. However, the concept is more generally applicable, not just for CA modules.

### Multi-Input and Multi-Output (MIMO) Communications

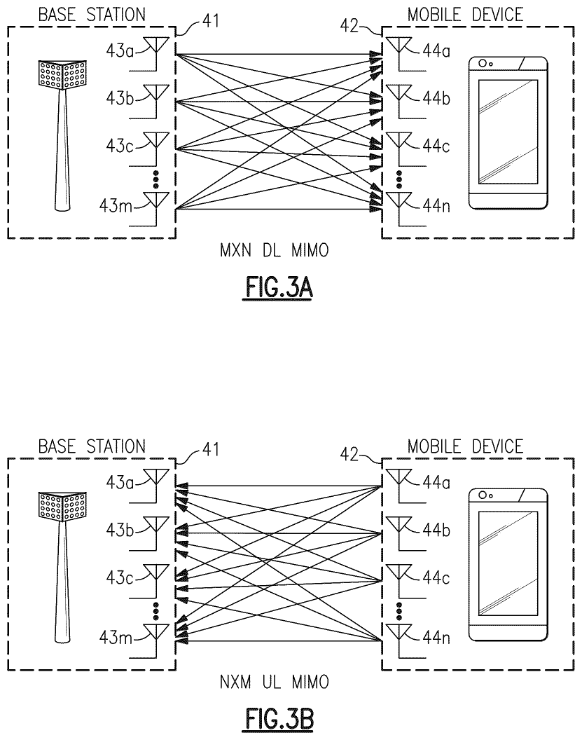

FIG. 3A is a schematic diagram of one example of a downlink channel using multi-input and multi-output (MIMO) communications. FIG. 3B is schematic diagram of one example of an uplink channel using MIMO communications.

MIMO communications use multiple antennas for simultaneously communicating multiple data streams over common frequency spectrum. In certain implementations, the data streams operate with different reference signals to enhance data reception at the receiver. MIMO communications benefit from higher SNR, improved coding, and/or reduced signal interference due to spatial multiplexing differences of the radio environment.

MIMO order refers to a number of separate data streams sent or received. For instance, MIMO order for downlink communications can be described by a number of transmit antennas of a base station and a number of receive antennas for UE, such as a mobile device. For example, two-by-two (2×2) DL MIMO refers to MIMO downlink communications using two base station antennas and two UE antennas. Additionally, four-by-four (4×4) DL MIMO refers to MIMO downlink communications using four base station antennas and four UE antennas.

In the example shown in FIG. 3A, downlink MIMO communications are provided by transmitting using M antennas 43a, 43b, 43c, . . . 43m of the base station 41 and receiving using N antennas 44a, 44b, 44c, . . . 44n of the mobile device 42. Accordingly, FIG. 3A illustrates an example of M×N DL MIMO.

Likewise, MIMO order for uplink communications can be described by a number of transmit antennas of UE, such as a mobile device, and a number of receive antennas of a base station. For example, 2×2 UL MIMO refers to MIMO uplink communications using two UE antennas and two base station antennas. Additionally, 4×4 UL MIMO refers to MIMO uplink communications using four UE antennas and four base station antennas.

In the example shown in FIG. 3B, uplink MIMO communications are provided by transmitting using N antennas 44a, 44b, 44c, . . . 44n of the mobile device 42 and receiving using M antennas 43a, 43b, 43c, . . . 43m of the base station 41. Accordingly, FIG. 3B illustrates an example of N×M UL MIMO.

By increasing the level or order of MIMO, bandwidth of an uplink channel and/or a downlink channel can be increased.

MIMO communications are applicable to dual connectivity and to communication links of a variety of types, such as FDD communication links and TDD communication links.

MIMO is one application/architecture where the concept of the present invention works well. However, the concept is more generally applicable, not just for MIMO modules.

### Examples of Radio Frequency Electronics

A radio frequency (RF) communication device can include multiple antennas for supporting wireless communications. Additionally, the RF communication device can include a radio frequency front-end (RFFE) system for processing signals received from and transmitted by the antennas. The RFFE system can provide a number of functions, including, but not limited to, signal filtering, controlling component connectivity to the antennas, and/or signal amplification.

RFFE systems can be used to handle RF signals of a wide variety of types, including, but not limited to, wireless local area network (WLAN) signals, Bluetooth signals, and/or cellular signals.

Additionally, RFFE systems can be used to process signals of a wide range of frequencies. For example, certain RFFE systems can operate using one or more low bands (for example, RF signal bands having a frequency content of 1 GHz or less, also referred to herein as LB), one or more mid bands (for example, RF signal bands having a frequency content between 1 GHz and 2.3 GHZ, also referred to herein as MB), one or more high bands (for example, RF signal bands having a frequency content between 2.3 GHz and 3 GHZ, also referred to herein as HB), and one or more ultrahigh bands (for example, RF signal bands having a frequency content between 3 GHz and 6 GHz, also referred to herein as UHB).

RFFE systems can be used in a wide variety of RF communication devices, including, but not limited to, smartphones, base stations, laptops, handsets, wearable electronics, and/or tablets.

A RFFE system can be implemented to support a variety of features that enhance bandwidth and/or other performance characteristics of the RF communication device in which the RFFE system is incorporated.

In one example, a RFFE system is implemented to support carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels, for instance up to five carriers. Carrier aggregation includes contiguous aggregation, in which contiguous carriers within the same operating frequency band are aggregated. Carrier aggregation can also be non-contiguous, and can include carriers separated in frequency within a common band or in different bands.

In another example, a RFFE system is implemented to support multi-input and multi-output (MIMO) communications to increase throughput and enhance mobile broadband service. MIMO communications use multiple antennas for communicating multiple data streams over a single radio frequency channel. MIMO communications benefit from higher signal to noise ratio, improved coding, and/or reduced signal interference due to spatial multiplexing differences of the radio environment.

MIMO order refers to a number of separate data streams sent or received. For instance, a MIMO order for downlink communications can be described by a number of transmit antennas of a base station and a number of receive antennas for user equipment (UE), such as a mobile device.

RFFE systems that support carrier aggregation and multi-order MIMO can be used in RF communication devices that operate with wide bandwidth. For example, such RFFE systems can be used in applications servicing multimedia content streaming at high data rates.

Fifth Generation (5G) technology seeks to achieve high peak data rates above 10 Gbps. Certain 5G high-speed communications can be referred to herein as Enhanced Multi-user Broadband (eMBB).

To achieve eMBB data rates, RF spectrum available at millimeter wave frequencies (for instance, 30 GHz and higher) is attractive, but significant technical hurdles are present in managing the loss, signal conditioning, radiative phased array aspects of performance, beam tracking, test, and/or packaging in the handset associated with millimeter wave communications.

The RFFE systems herein can operate using not only LB, MB, and HB frequencies, but also ultrahigh band (UHB) frequencies in the range of about 3 GHz to about 6 GHz, and more particular between about 3.4 GHz and about 3.8 GHz. By communicating using UHB, enhanced peak data rates can be achieved without the technical hurdles associated with millimeter wave communications.

In certain implementations herein, UHB transmit and receive modules are employed for both transmission and reception of UHB signals via at least two primary antennas and at least two diversity antennas, thereby providing both 4×4 RX MIMO and 4×4 TX MIMO with respect to one or more UHB frequency bands, such as Band 42 (about 3.4 GHz to about 3.6 GHz), Band 43 (about 3.6 GHz to about 3.8 GHz), and/or Band 48 (about 3.55 GHz to about 3.7 GHZ). Furthermore, in certain configurations, the RFFE systems herein employ carrier aggregation using one or more UHB carrier frequencies, thereby providing flexibility to widen bandwidth for uplink and/or downlink communications.

By enabling high-order MIMO and/or carrier aggregation features using UHB spectrum, enhanced data rates can be achieved. Additionally, rather than using dedicated 5G antennas and a separate transceiver, shared antennas and/or a shared transceiver (for example, a semiconductor die including a shared transceiver fabricated thereon) can be used for both 5G UHB communications and 4G/LTE communications associated with HB, MB, and/or LB. Thus, 4G/LTE communications systems can be extended to support sub-6 GHz 5G capabilities with a relatively small impact to system size and/or cost.

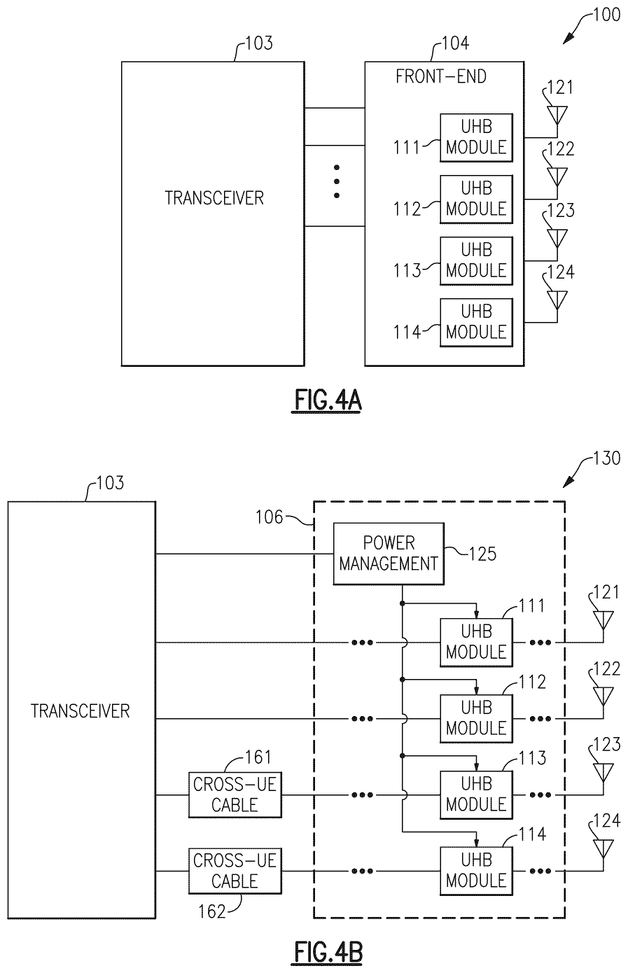

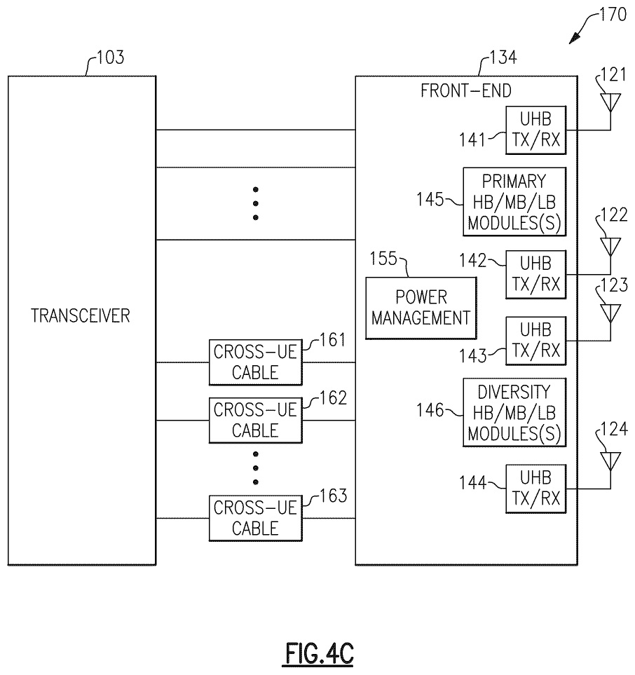

FIG. 4A is a schematic diagram of a RF system 100. The RF system 100 includes a radio frequency integrated circuit (RFIC) or transceiver 103, a front-end system 104 and antennas 121-124. In certain implementations, the antenna 121 is a first primary antenna, the antenna 122 is a second primary antenna, the antenna 123 is a first diversity antenna, and the antenna 124 is a second diversity antenna.

Although the RF system 100 is depicted as including certain components, other implementations are possible, including, but not limited to, implementations using other numbers of antennas, different implementations of components, and/or additional components.

The front-end system 104 includes a first UHB module 111, a second UHB module 112, a third UHB module 113, and a fourth UHB module 114. The front-end system 104 further includes separate antenna terminals for coupling to each of the antennas 121-124.

Thus, the front-end system 104 of FIG. 4A includes multiple UHB modules for supporting communications of UHB signals across multiple antennas. For example, in certain implementations, the UHB modules 111-114 are configured to transmit and receive UHB signals via the antennas 121-124, respectively. Accordingly, broadband communications via UHB frequency carriers can be achieved.

For clarity of the figures, the front end system 104 is depicted as including only the UHB modules 111-114. However, the front end system 104 typically includes additionally components and circuits, for example, modules associated with LB, MB, and/or HB cellular communications. Furthermore, modules can be included for Wi-Fi, Bluetooth, and/or other non-cellular communications.

FIG. 4B is a schematic diagram of a RF system 130. The RF system 130 includes a transceiver 103, a front-end system 106, a first primary antenna 121, a second primary antenna 122, a first diversity antenna 123, a second diversity antenna 124, a first cross-UE cable 161, and a second cross-UE cable 162. As shown in FIG. 4B, the front-end system 106 includes a first UHB module 111, a second UHB module 112, a third UHB module 113, a fourth UHB module 114, and a power management circuit 125. The front-end system 106 further includes a first primary antenna terminal for coupling to the first primary antenna 121, a second primary antenna terminal for coupling to the second primary antenna 122, a first diversity antenna terminal for coupling to the first diversity antenna 123, and a second diversity antenna terminal for coupling to the second diversity antenna 124.

As shown in FIG. 4B, the first UHB module 111 and the second UHB module 112 communicate using the first primary antenna 121 and the second primary antenna 122, respectively, and are connected to the transceiver 103 without the use of cross-UE cables. Additionally, the third UHB module 113 and the fourth UHB module 114 communicate using the first diversity antenna 123 and the second diversity antenna 124, respectively, and are connected to the transceiver 103 using the first cross-UE cable 161 and the second cross-UE cable 162, respectively.

To reduce the statistical correlation between received signals, the primary antennas 121-122 and the diversity antennas 123-124 can be separated by a relatively large physical distance in the RF system 130. For example, the diversity antennas 123-124 can be positioned near the top of the device and the primary antennas 121-122 can be positioned near the bottom of the device, or vice-versa. Additionally, the transceiver 103 can be positioned near the primary antennas 121-122 and primary modules to enhance performance of primary communications.

Accordingly, in certain implementations, the UHB modules 113-114 and diversity antennas 123-124 can be located at relatively far physical distance from the transceiver 103 and connected to the transceiver 103 via cross-UE cables 161-162, respectively.

In the illustrated example, the front-end system 106 further includes a shared power management circuit 125 used to provide a supply voltage, such as a power amplifier supply voltage, to the UHB modules 111-114.

Providing power to the UHB modules 111-114 using the shared power management circuit 125 can provide a number of advantages, including, for example, high integration, reduced component count, and/or lower cost.

In certain implementations, the shared power management circuit 125 operates using average power tracking (APT), in which the voltage level of the supply voltage provided by the shared power management circuit 125 is substantially fixed over a given communication time slot. In certain implementations, the supply voltage has a relatively high voltage, and thus operates with a corresponding low current. Thus, although the UHB modules 111-114 can be distributed across the device over relatively wide distances and connected using resistive cables and/or conductors, power or I<2>*R losses can be relatively small.

Accordingly, the shared power management circuit 125 can provide high integration with relatively low power loss.

FIG. 4C is a schematic diagram of a RF system 170 according to another example. The RF system 170 includes a transceiver 103, a front-end system 134, a first primary antenna 121, a second primary antenna 122, a first diversity antenna 123, a second diversity antenna 124, a first cross-UE cable 161, a second cross-UE cable 162, and a third cross-UE cable 163.

The illustrated RF system 170 is used to transmit and receive signals of a wide variety of frequency bands, including LB, MB, HB, and UHB cellular signals. For example, the RF system 170 can process one or more LB signals having a frequency content of 1 GHz or less, one or more MB signals having a frequency content between 1 GHz and 2.3 GHz, one or more HB signals having a frequency content between 2.3 GHz and 3 GHZ, and one or more UHB signals have a frequency content between 3 GHz and 6 GHz. Examples of LB frequencies include, but are not limited to Band 8, Band 20, and Band 26. Examples of MB frequencies include, but are not limited to, Band 1, Band 3, Band 4, and Band 66. Examples of HB frequencies include, but are not limited to, Band 7, Band 38, and Band 41. Examples of UHB frequencies include, but are not limited to, Band 42, Band 43, and Band 48.

The illustrated front-end system 134 includes one or more primary modules 145 used for transmitting and receive HB, MB, and/or LB signals via the primary antennas 121-122. Although illustrated as a single block, the primary modules 145 can include multiple modules collectively used to transmit and receive HB, MB, and/or LB signals via the first primary antenna 121 and the second primary antenna 122. Additionally, in certain implementations, the first primary antenna 121 and the second primary antenna 122 can be used for communicating over certain frequency ranges. For instance, in one example, the second primary antenna 122 supports LB communications but the first primary antenna 121 does not support LB communications.

With continuing reference to FIG. 4C, the front-end system 134 further includes one or more diversity modules 146 used for receiving HB, MB, and/or LB diversity signals via the diversity antennas 123-124. In certain implementations, the diversity modules 146 operate to receive but not transmit diversity signals. In other implementations, the diversity modules 146 also can be used for transmitting HB, MB, and/or LB signals.

In the illustrated example, the front-end system 134 further includes a first UHB transmit and receive (TX/RX) module 141 electrically coupled to the first primary antenna 121, a second UHB transmit and receive module 142 electrically coupled to the second primary antenna 122, a third UHB transmit and receive module 143 electrically coupled to the first diversity antenna 123, and a fourth UHB transmit and receive module 144 electrically coupled to the second diversity antenna 124. The front-end system 134 further includes a first primary antenna terminal for coupling to the first primary antenna 121, a second primary antenna terminal for coupling to the second primary antenna 122, a first diversity antenna terminal for coupling to the first diversity antenna 123, and a second diversity antenna terminal for coupling to the second diversity antenna 124.

In the illustrated example, the UHB transmit and receive modules 141-144 support transmit and receive of one or more UHB frequency bands, including, but not limited to, Band 42, Band 43, and/or Band 48.

Accordingly, the UHB transmit and receive modules 141-144 can be used to support 4×4 RX MIMO for UHB, 4×4 TX MIMO for UHB, and/or carrier aggregation using one or more UHB frequency carriers. Carrier aggregation using UHB frequency spectrum can include not only carrier aggregation using two or more UHB frequency carriers, but also carrier aggregation using one or more UHB frequency carriers and one or more non-HB frequency carriers, such as HB and/or MB frequency carriers.

In certain communications networks, a user demand for high downlink data rates can exceed a demand for high uplink data rates. For instance, UEs of the network, such as smartphones, may desire high speed downloading of multimedia content, but uploading relatively little data to the cloud. This in turn, can lead to the network operating with a relatively low UL to DL time slot ratio and limited opportunities for UL communications.

However, DL data rate of a network can be limited or bottlenecked by an UL data rate. For instance, in certain networks, UL data rate must stay within about 5% of DL data rate to support control, acknowledgement, and other overhead associated with the communication link. Accordingly, higher DL data rates can be achieved by increasing UL data rate.

The front-end system 134 of FIG. 4C includes UHB transmit and receive modules that advantageously support both transmission and reception of UHB signals. Accordingly, broadband UL communications via UHB frequency carriers can be achieved, thereby enhancing UL data rate and providing sufficient UL bandwidth to support overhead associated with very high data rate DL communications.

The illustrated RF system 170 advantageously includes four transmit capable UHB transmit and receive modules 141-144 coupled to the antennas 121-124, respectively. Thus, both transmit and receive are equally available at each of the antennas 121-124 for UHB communications. Thus, antenna swap can be accomplished without a swap switch to redirect a trace or route. For example, antenna selection can be achieved by controlling whether or not each UHB transmit and receive module is transmitting or receiving. Accordingly, the RF system 170 achieves antenna swap functionality for UHB without using any antenna swap switch.

In the illustrated example, a shared or common transceiver 103 is used for both 4G/LTE communications using HB, MB, and LB frequencies, and also for UHB communications supporting sub-6 GHz 5G. Thus, rather than using a separate or dedicated 5G front-end and antenna interface, the shared transceiver 103 is used for both 4G/LTE communications via HB, MB, and LB frequencies and 5G UHB communications.

The illustrated RF system 170 also employs diversity communications to enhance performance. To reduce the correlation between received signals, the primary antennas 121-122 and the diversity antennas 123-124 can be separated by a relatively large physical distance in the RF system 170. For example, the diversity antennas 123-124 can be positioned near the top of the device and the primary antennas 121-122 can be positioned near the bottom of the device or vice-versa. Additionally, the transceiver 103 can be positioned near the primary antennas 121-122 and primary modules to enhance performance of primary communications.

Accordingly, in certain implementations, the UHB transmit and receive modules 143-144, the diversity module(s) 146, and the diversity antennas 123-124 can be located at relatively far physical distance from the transceiver 103 and connected to the transceiver 103 via cross-UE cables 161-163. Additionally, the UHB transmit and receive modules 141-144 can be distributed and/or placed in remote locations around the RF system 170. Although three cross-UE cables are illustrated, more or fewer cross-UE cables can be included as indicated by the ellipsis.

In the illustrated example, the front-end system 134 further includes a power management circuit 155. In certain implementations, the power management circuit 155 is used to provide a supply voltage, such as a power amplifier supply voltage, which is shared by multiple components including the UHB transmit and receive modules 141-144.

Providing power to the UHB transmit and receive modules 141-144 using a shared power management circuit can provide a number of advantages, including, for example, high integration, reduced component count, and/or lower cost.

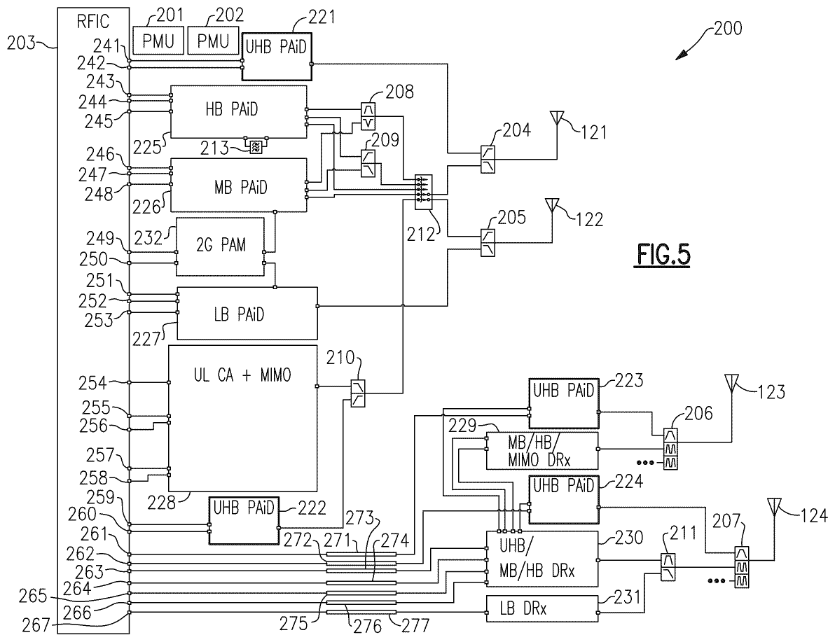

FIG. 5 is a schematic diagram of a RF system 200. The RF system 200 includes a first primary antenna 121, a second primary antenna 122, a first diversity antenna 123, a second diversity antenna 124, a first power management unit (PMU) 201, a second PMU 202, a transceiver or RFIC 203, a first primary antenna diplexer 204, a second primary antenna diplexer 205, a first diversity antenna triplexer 206, a second diversity antenna triplexer 207, a first HB/MB diplexer 208, a second HB/MB diplexer 209, a MIMO/UHB diplexer 210, a diversity diplexer 211, a multi-throw switch 212, a HB TDD filter 213, a first UHB power amplifier with integrated duplexer (PAID) module 221, a second UHB PAID module 222, a third UHB PAID module 223, a fourth UHB PAID module 224, an HB PAID module 225, an MB PAID module 226, an LB PAID module 227, an UL CA and MIMO module 228, an MB/HB MIMO diversity receive (DRx) module 229, a UHB/MB/HB DRx module 230, an LB DRx module 231, a 2G power amplifier module (PAM) 232, a first cross-UE cable 271, a second cross-UE cable 272, a third cross-UE cable 273, a fourth cross-UE cable 274, a fifth cross-UE cable 275, a sixth cross-UE cable 276, and a seventh cross-UE cable 277.

The RF system 200 includes a RFFE that provides full sub-6 GHz 5G capability provided by four remote placements of UHB PAID modules 221-224. Although one specific example of an RF system with UHB modules is shown, the teachings herein are applicable to RF electronics implemented in a wide variety of ways. Accordingly, other implementations are possible.

As shown in FIG. 5, the first UHB PAID module 221 is coupled to the first primary antenna 121, and the second UHB PAID module 222 is coupled to the second primary antenna 122. Additionally, the third UHB PAID module 223 is coupled to the first diversity antenna 123, and the fourth UHB PAID module 224 is coupled to the second diversity antenna 124. Accordingly, one UHB PAID module is included for each of the four antennas of this example.

In certain implementations, the UHB PAID modules 221-224 support transmit and receive of one or more UHB frequency bands, including, but not limited to, Band 42, Band 43, and/or Band 48.

The RF system 200 of FIG. 5 supports 4×4 RX MIMO for UHB, 4×4 TX MIMO for UHB, and carrier aggregation (CA) with 4G and/or 5G bands.

As will be described below, the first PMU 201 and the second PMU 202 are used to provide power management to certain modules. For clarity of the figures, a connection from each PMU to the modules it powers is omitted from FIG. 5 to avoid obscuring the drawing.

In the illustrated example, the first PMU 201 operates as a shared power management circuit for the first UHB PAID module 221, the second UHB PAID module 222, the third UHB PAID module 223, and the fourth UHB PAID module 224. The first PMU 201 can be used, for example, to control a power supply voltage level of the UHB PAID modules' power amplifiers. Additionally, the first PMU 201 is also shared with the HB PAID module 225, which transmits and receives HB signals on the first primary antenna 121 and the second primary antenna 122, and with the UL CA and MIMO module 228 used for enhancing MIMO order and a maximum number of supported carriers for carrier aggregation. Thus, the first PMU 201 provides a shared power supply voltage to the UHB PAID modules 221-224, the HB PAID module 225, and the UL CA and MIMO module 228, in this example.

By sharing the first PMU 201 in this manner, a common power management scheme, such as fixed supply wide bandwidth average power tracking (APT), can be advantageously used for the modules.

In the illustrated example, the second PMU 202 generates a shared power supply voltage used by the MB PAID 226 and by the LB PAID module 227.

In certain implementations, the diversity modules and diversity antennas can be located at relatively far physical distance from the RFIC 203, and connected to the RFIC 203 via cross-UE cables 271-277. Thus, the UHB PAID modules 221-224 can be placed in remote locations around the UE phone board.

In certain examples herein, a PMU is shared between at least one UHB module and at least one a HB module or a MB module.

The illustrated RF system 200 of FIG. 5 advantageously includes four transmit capable UHB PAID modules 221-224 coupled to four separate antennas 121-124, respectively, and thus both transmit and receive are equally available at each antenna for UHB communications.

Accordingly, antenna swap can be accomplished without a swap switch to redirect a trace or route. For example, antenna selection can be achieved by controlling which UHB power amplifier(s) of the UHB PAID modules 221-224 are enabled. Similarly, with respect to receive, the antenna selection can be made by controlling which UHB low noise amplifier(s) of the UHB PAID modules 221-224 are turned on. Thus, in this example, antenna swap functionality is achieved without using any antenna swap switch.

In certain implementations, the RFIC of FIG. 5 can provide beam steering and/or different data streams through digital baseband control of a relative phase difference between signals provided to the UHB PAID modules 221-224.

In the illustrated example, the first primary antenna diplexer 204 operates to diplex between UHB frequencies and MB/HB frequencies. Additionally, the second primary antenna diplexer 205 operates to diplex between MB/HB/UHB frequencies and LB frequencies. Furthermore, the first diversity antenna triplexer 206 operates to triplex between UHB frequencies, MB/HB frequencies, and 2 GHz/5 GHz Wi-Fi frequencies. Additionally, the second diversity antenna triplexer 207 operates to triplex between UHB frequencies, LB/HB/MB frequencies, and 2 GHz/5 GHz Wi-Fi frequencies. For clarity of the figures, Wi-Fi modules connected to the first diversity antenna triplexer 206 and to the second diversity antenna triplexer 207 are not illustrated.

With continuing reference to FIG. 5, the first HB/MB diplexer 208 operates to diplex between a first group of HB frequencies (for example, Band 30 and/or Band 40) and MB frequencies. Additionally, the second HB/MB diplexer 209 operates to diplex between a second group of HB frequencies (for example, Band 7 and/or Band 41) and MB frequencies. Furthermore, the MIMO/UHB diplexer 210 operates to diplex between MB/HB frequencies and UHB frequencies. Additionally, the diversity diplexer 211 operates to diplex between MB/HB frequencies and LB frequencies.

In the illustrated example, the RFIC 203 includes a first RX UHB terminal 241, a first TX UHB terminal 242, a first RX HB terminal 243, a second RX HB terminal 244, a TX HB terminal 245, a first RX MB terminal 246, a second RX MB terminal 247, a first TX MB terminal 248, a 2G TX MB terminal 249, a 2G RX MB terminal 250, a first RX LB terminal 251, a second RX LB terminal 252, a TX LB terminal 253, a second TX MB terminal 254, a third RX MB terminal 255, a fourth RX MB terminal 256, a third RX HB terminal 257, a fourth RX HB terminal 258, a second RX UHB terminal 259, a second TX UHB terminal 260, a third TX UHB terminal 261, a fourth TX UHB terminal 262, a first shared RX UHB/HB terminal 263, a second shared RX UHB/HB terminal 264, a first shared RX MB/HB terminal 265, a second shared RX MB/HB terminal 266, and an LB RX terminal 267. As shown in FIG. 5, certain terminals are shared across multiple bands to share resources and/or reduce signal routes (for instance, to use fewer cross-UE cables).

Although one example of a RF system 200 is shown in FIG. 5, the teachings herein are applicable to RF systems implemented in a wide variety of ways.

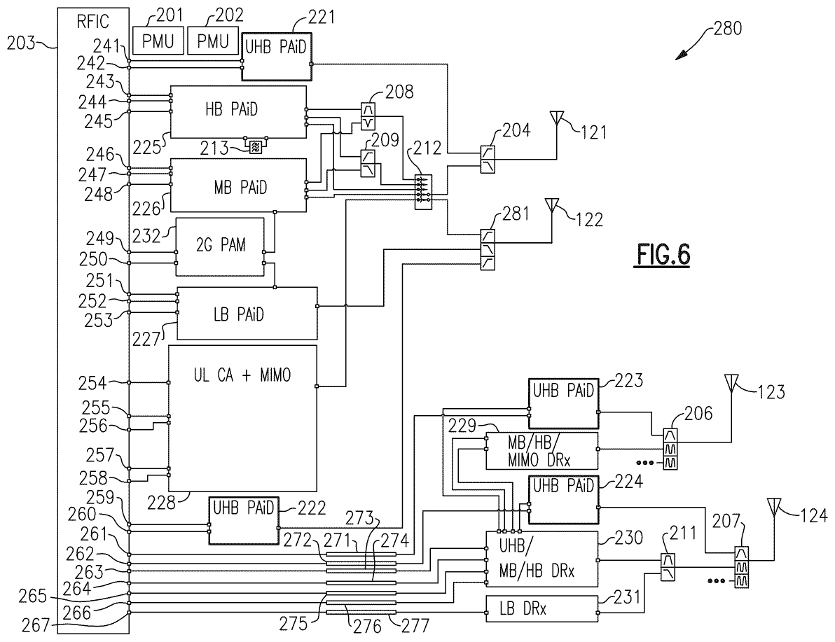

FIG. 6 is a schematic diagram of an RF system 280 according to another example. The RF system 280 includes a first primary antenna 121, a second primary antenna 122, a first diversity antenna 123, a second diversity antenna 124, a first PMU 201, a second PMU 202, a RFIC 203, a primary antenna diplexer 204, a primary antenna triplexer 281, a first diversity antenna triplexer 206, a second diversity antenna triplexer 207, a first HB/MB diplexer 208, a second HB/MB diplexer 209, a diversity diplexer 211, a multi-throw switch 212, an HB TDD filter 213, a first UHB PAID module 221, a second UHB PAID module 222, a third UHB PAID module 223, a fourth UHB PAID module 224, an HB PAID module 225, an MB PAID module 226, an LB PAID module 227, an UL CA and MIMO module 228, an MB/HB MIMO DRx module 229, a UHB/MB/HB DRx module 230, an LB DRx module 231, a 2G PAM 232, and first to seventh cross-UE cables 271-277, respectively.

The RF system 280 of FIG. 6 is similar to the RF system 200 of FIG. 5, except that the RF system 280 of FIG. 6 includes the primary antenna triplexer 281 rather than the second primary antenna diplexer 205, and omits the MIMO/UHB diplexer 210 in favor of connecting the second UHB PAID module 222 to the second primary antenna 122 by way of the primary antenna triplexer 281.

Implementing the RF system 280 in this manner connects the second UHB PAID module 222 to the second primary antenna 122 with lower loss relative to the example of FIG. 5. Thus, the RF system 280 of FIG. 6 has lower insertion loss for certain UHB signal paths, which can enhance the performance of certain CA combinations and/or when operating using UHB MIMO communications.

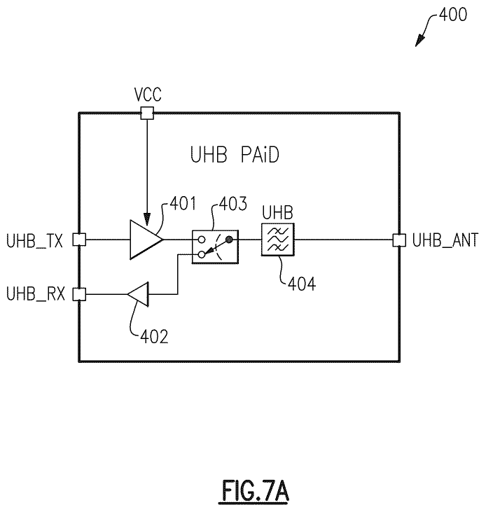

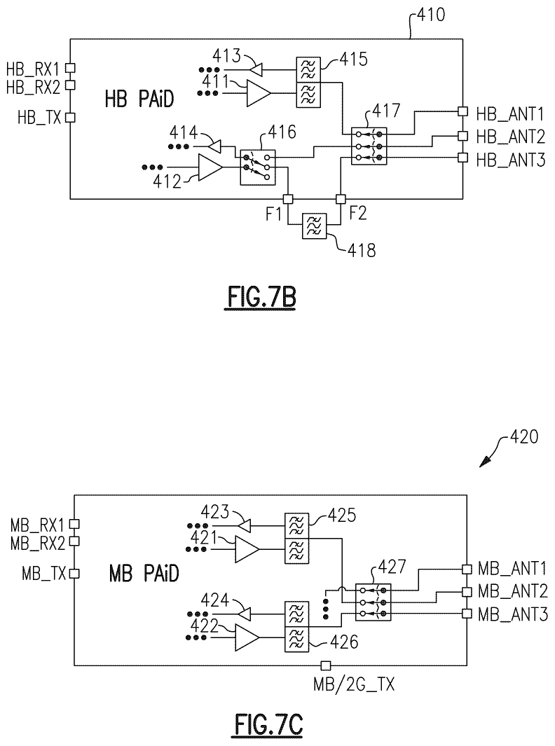

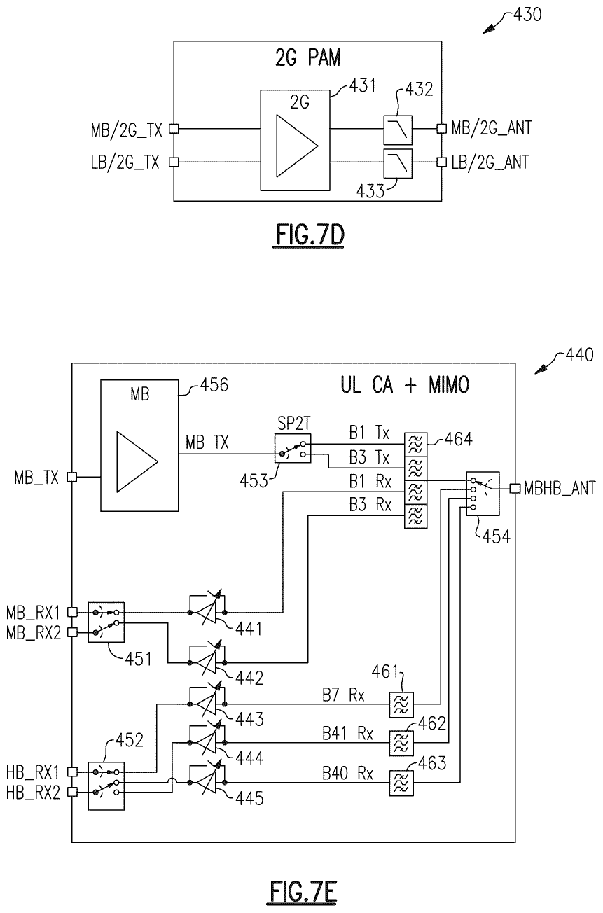

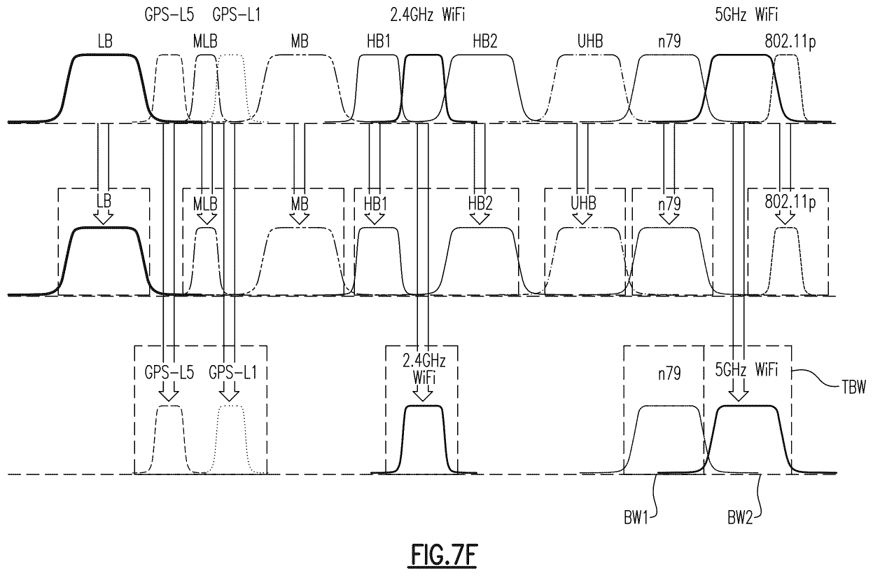

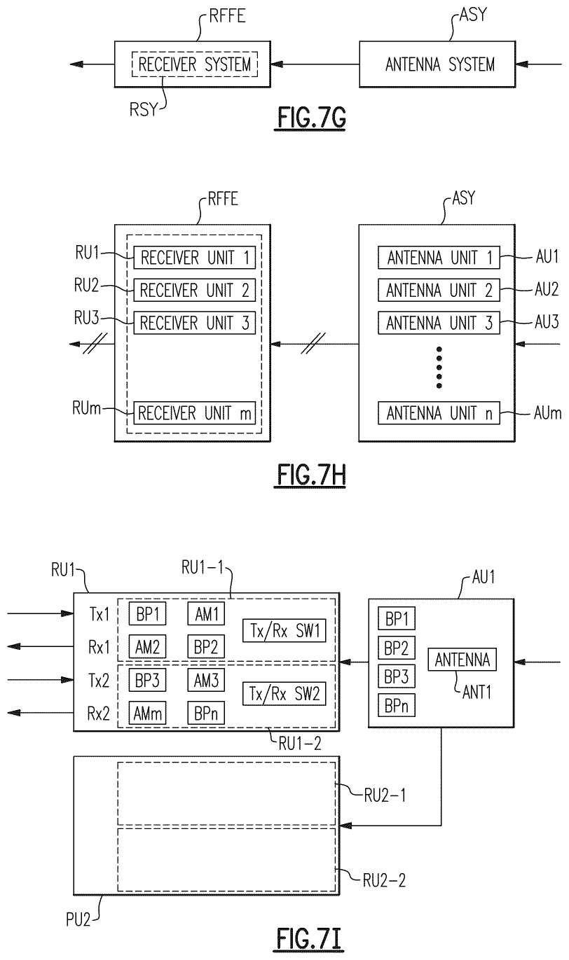

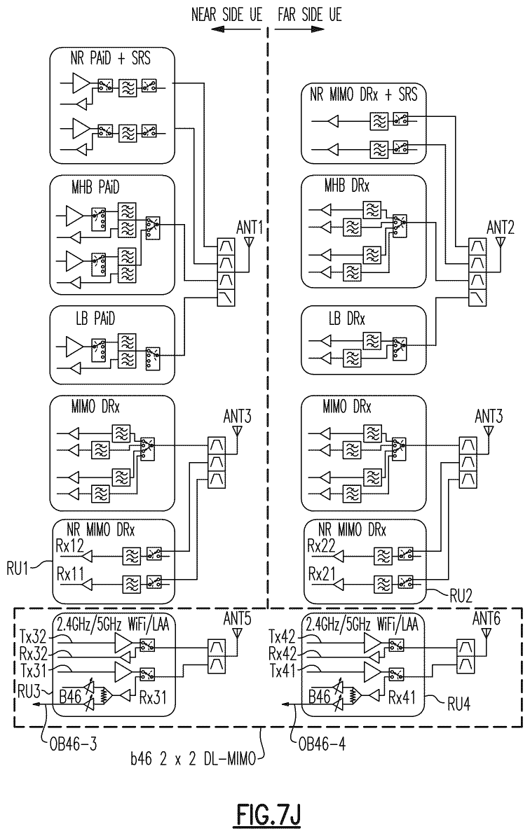

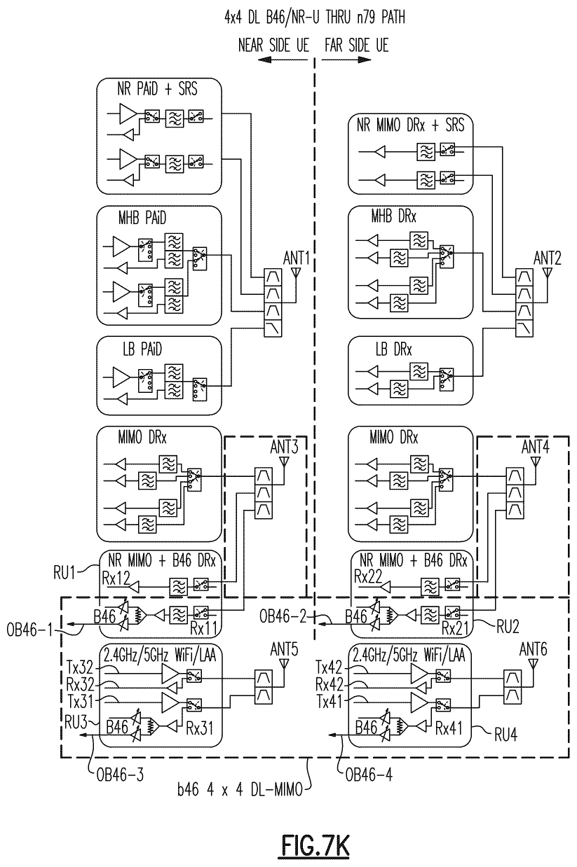

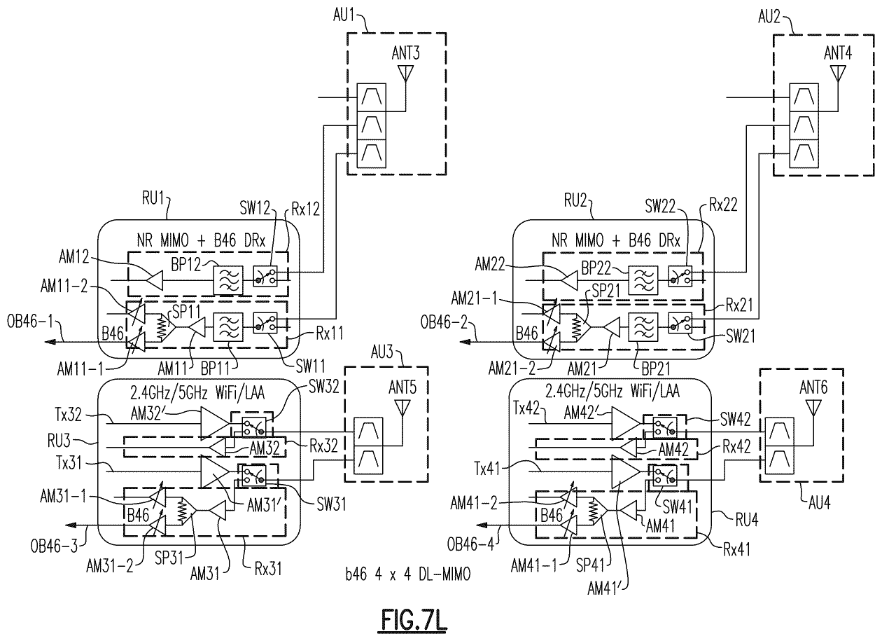

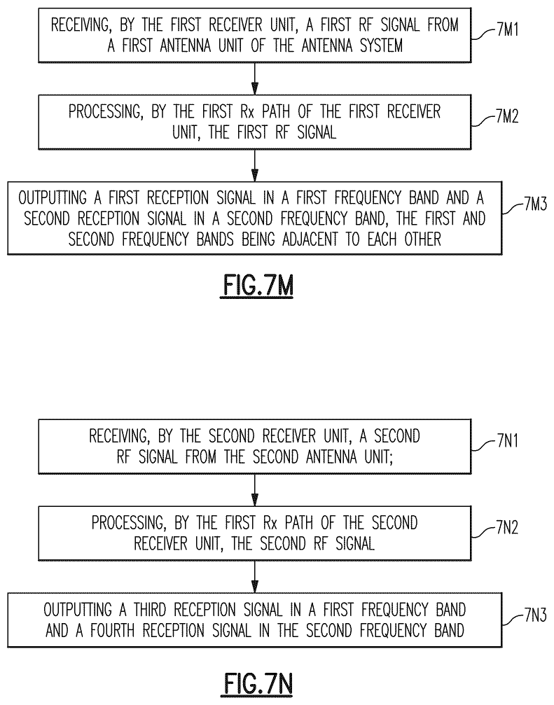

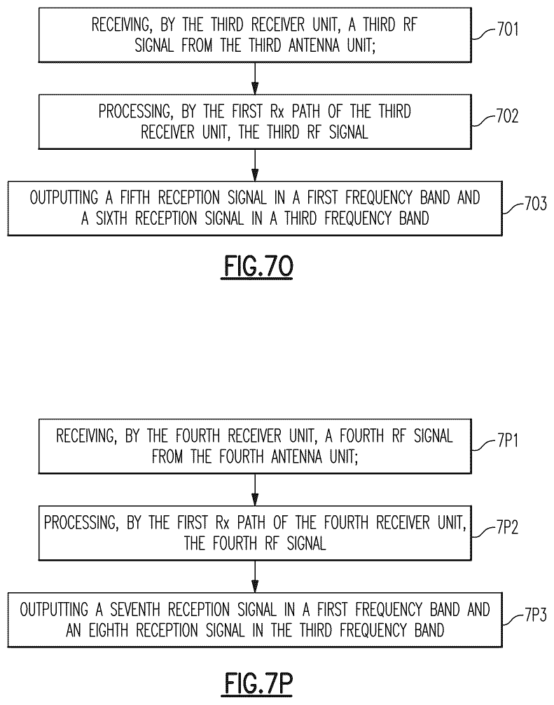

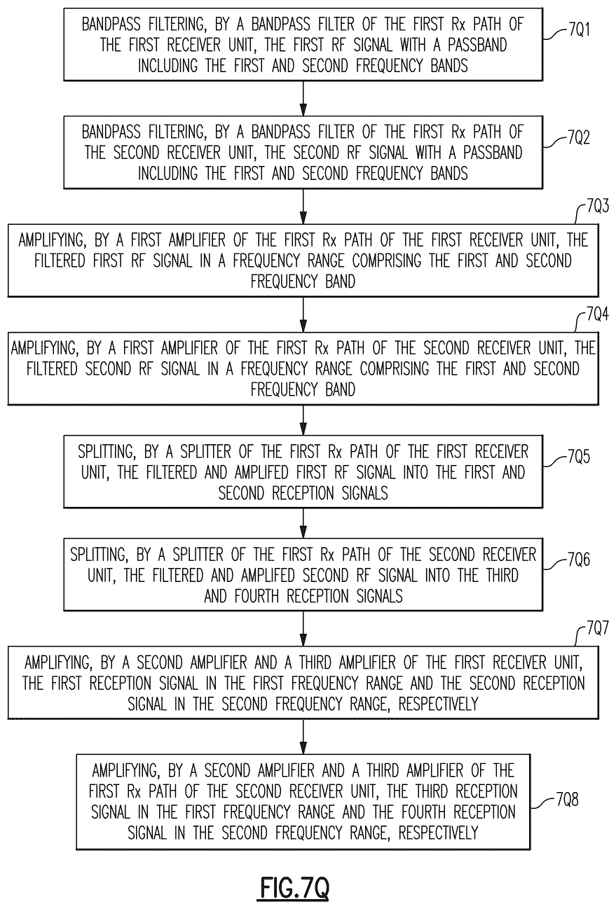

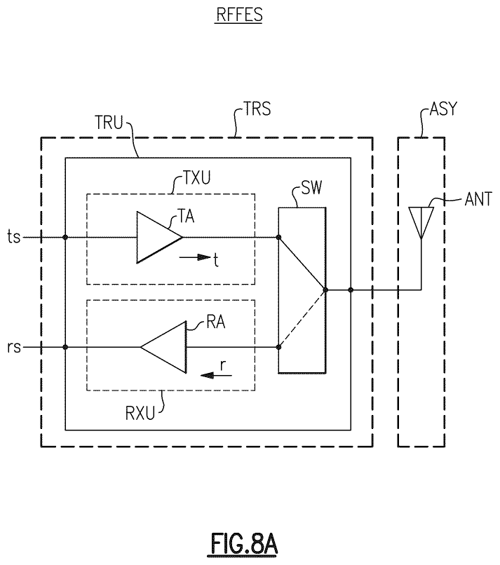

FIG. 7A is a schematic diagram of a UHB transmit and receive module 400 according to one example. The UHB transmit and receive module 400 operates to generate a UHB signal for transmission and to process a UHB signal received from an antenna.

The UHB transmit and receive module 400 illustrates one implementation of a UHB module suitable for incorporation in a RF system, such as any of the RF systems of FIGS. 4A-6. Although the UHB transmit and receive module 400 illustrates one implementation of a UHB module, the teachings herein are applicable to RF electronics including UHB modules implemented in a wide variety of ways. Accordingly, other implementations of UHB modules are possible, such as UHB modules with more or fewer pins, different pins, more or fewer components, and/or a different arrangement of components.

The UHB transmit and receive module 400 includes a power amplifier 401, a low noise amplifier 402, a transmit/receive switch 403, and a UHB filter 404, which is used to pass one or more UHB bands, for instance, Band 42, Band 43, and/or Band 48. The UHB transmit and receive module 400 further includes a variety of pins, including a UHB_TX pin for receiving a UHB transmit signal for transmission, a UHB_RX pin for outputting a UHB receive signal, a UHB_ANT pin for connecting to an antenna, and a VCC pin for receiving a supply voltage for powering at least the power amplifier 401. In certain implementations, the VCC pin receives a shared supply voltage from a power management circuit (for example, a PMU) shared by multiple modules.

The illustrated UHB transmit and receive module 400 provides both transmit and receive functionality for UHB signals. Thus, when four instantiations of the UHB transmit and receive module 400 are coupled directly or indirectly to four antennas, both 4×4 RX MIMO for UHB and 4×4 TX MIMO for UHB can be achieved. Additionally, the UHB transmit and receive modules can be used to support carrier aggregation for UL and/or DL using one or more UHB carrier frequencies.

FIG. 7B is a schematic diagram of a HB transmit and receive module 410 according to one example.

The RF systems disclosed herein can include one or more implementations of the HB transmit and receive module 410. Although the HB transmit and receive module 410 illustrates one implementation of an HB module, the teachings herein are applicable to RF electronics including HB modules implemented in a wide variety of ways as well as to RF electronics implemented without HB modules.

The HB transmit and receive module 410 includes a first power amplifier 411 for FDD communications, a second power amplifier 412 for TDD communications, a first low noise amplifier 413 for FDD communications, a second low noise amplifier 414 for TDD communications, an FDD duplexer 415, a transmit/receive switch 416, and a multi-throw switch 417. An external TDD filter 418 is also included in this example. In another example, the TDD filter 418 is included within the module 410.

The HB transmit and receive module 410 further includes a variety of pins, including an HB_TX pin for receiving an HB transmit signal for transmission, an HB_RX1 pin for outputting a first HB receive signal, an HB_RX2 pin for outputting a second HB receive signal, an F1 pin for connecting to one terminal of the external TDD filter 418, and an F2 pin for connecting to another terminal of the external TDD filter 418. The module 410 further includes an HB_ANT1 pin, an HB_ANT2 pin, and an HB_ANT3 pin for connecting to one or more antennas.

FIG. 7C is a schematic diagram of a MB transmit and receive module 420 according to one example.

The RF systems disclosed herein can include one or more implementations of the MB transmit and receive module 420. Although the MB transmit and receive module 420 illustrates one implementation of a MB module, the teachings herein are applicable to RF electronics including MB modules implemented in a wide variety of ways as well as to RF electronics implemented without MB modules.

The MB transmit and receive module 420 includes a first power amplifier 421, a second power amplifier 422, a first low noise amplifier 423, a second low noise amplifier 424, a first duplexer 425, a second duplexer 426, and a multi-throw switch 427. In certain implementations, the first duplexer 425 and the second duplexer 426 provide duplexing to different MB frequency bands. In one example, the first duplexer 425 is operable to duplex Band 3, while the second duplexer 426 is operable to duplex at least one of (or both of) Band 1 and Band 66.

The MB transmit and receive module 420 further includes a variety of pins, including an MB_TX pin for receiving an MB transmit signal for transmission, an MB_RX1 pin for outputting a first MB receive signal, an MB_RX2 pin for outputting a second MB receive signal, and an MB/2G_TX pin for receiving a 2G transmit signal for transmission. The module 420 further includes an MB_ANT1 pin, an MB_ANT2 pin, and an MB_ANT3 pin for connecting to one or more antennas.

FIG. 7D is a schematic diagram of a 2G power amplifier module (PAM) 430 according to one example. FIG. 7E is a schematic diagram of an exemplary uplink carrier aggregation an MIMO module.

The RF systems disclosed herein can include one or more instantiations of the 2G PAM 430. Although the 2G PAM 430 illustrates one implementation of a 2G module, the teachings herein are applicable to RF electronics including 2G modules implemented in a wide variety of ways as well as to RF electronics implemented without 2G modules.

The 2G PAM 430 includes power amplifier circuitry 431, an MB 2G filter 432, and an LB 2G filter 433. The 2G PAM 430 further includes a variety of pins, including an MB/2G_TX pin for receiving a 2G MB transmit signal for transmission and an LB/2G_TX pin for receiving a 2G LB transmit signal for transmission. The module 430 further includes an MB/2G_ANT pin and an LB/2G_ANT pin for connecting to one or more antennas.

RFFEs and Frequency Bands used for Wireless Mobile Communications

As already described with regard to the RF system 200 shown in FIG. 5, a RFFE, including four remote placements of UHB PAID modules 221-224 coupled to respective antennas 121-124, supports 4×4 RX MIMO for the UHB band, 4×4 TX MIMO for UHB, and carrier aggregation (CA) with 4G and/or 5G bands. Hence, the UHB PAID modules 221-224 support transmission and reception of one or more UHB frequency bands, including, but not limited to, band 42, band 4, three, and/or band 48.

However, there are of course further frequency bands which are used by different antenna groups for a mobile terminal (user equipment), supporting not only 4G and/or 5G bands, but also 2.4 GHz Wi-Fi and 5 GHz Wi-Fi, as shown in FIG. 7F. As shown in FIG. 7F, the respective frequency bands are in close proximity which drive isolation and insertion loss challenges. Since a user equipment (mobile terminal) has a limited space for the number of antennas on the near side and the far side of the user equipment, there are challenges in particular regarding the optimal band grouping and antenna flexing to achieve high isolation and low insertion.

As is shown in FIG. 7F, out of the different frequency bands shown on the top in FIG. 7F, certain antenna groups 1, 2 (each comprising bandpass filters and antennas) may be used for enabling operation in the different frequency bands. When steep bandpass filters are used (and the antennas are placed at far-away different positions in the mobile terminal), sufficient isolation can be achieved. However, since space for a large number of antennas (antenna units) is limited in the UE, it is impossible to achieve full 4×4 downlink and uplink MIMO simultaneously in all frequency bands. Regarding available bandwidth, whilst sufficient bandwidth is important also in the uplink, primarily the focus is on achieving 4×4 downlink MIMO in as many frequency bands as possible.

However, whilst there are many early available solutions for 4×4 DL MIMO in various frequency bands, for example, in the n77 or the n79 frequency bands, only 2×2 DL MIMO is available, using already available antenna systems in the mobile devices, for the very interesting b46 frequency band in the frequency range of 5150-5925 GHz, typically used for 5 GHz Wi-Fi, as is shown in FIG. 7F. That is, for the b46 frequency band, mobile devices typically only comprise two antennas which limits the reception to two reception paths.

However, FIG. 7F also shows that the existing n79 frequency band BW1 is directly adjacent to the frequency band BW2 used for downlink transmission in the 5 GHz Wi-Fi frequency band. In contrast to this, the 2.4 GHz Wi-Fi is situated far away from the bands BW1+BW2=TBW.

The present invention is based on the realization that the adjacency of the n79 frequency band and the 5 GHz Wi-Fi b46 frequency band can be used, without increasing the number of antenna units, to provide, in addition to the existing two downlink reception paths, two further downlink reception paths by re-using the already existing n79 downlink reception paths. This concept of the present invention will be explained below in detail with reference to FIG. 7K to FIG. 7Q.

### Example of RFFE System in a User Equipment

For providing better understanding how to re-use the n79 downlink reception path also for downlink in the 5 GHz Wi-Fi frequency band, first a typical RFFE system is described below with reference to FIG. 7G to FIG. 7I.

Typically, as was also shown above in FIG. 5, an RFFE system in FIG. 7G comprises an RFFE front end, RFFE, including a receiver system RSY coupled to an antenna system ASY. Typically, as shown in FIG. 7H, the RFFE includes a receiver system RSY comprising a plurality of receiver units RU1, RU2, RU3 . . . . RUm. These receiver units are coupled to a plurality of antenna units AU1, AU2, AU3 . . . . AUn of the antenna system ASY. Typically, as will also be seen from the more detailed block diagram in FIG. 7J, the receiver units are essentially provided for different frequency bands, and also the antenna units comprise different antennas and bandpass filters to be applied for certain frequency bands. However, not necessarily will the number M of receiver units M be equal to the number N of antenna units. That is, due to space restrictions, the antenna units (with their bandpass filters) are designed in such a manner that allows re-use of the antenna units for different receiver units, depending on the location (frequency-wise) of the frequency bands (this is also illustrated in FIG. 7F with the different frequency bands used by the antenna group 1 and the antenna group 2).

A re-use of antenna units for two receiver units RU1, RU2 is also shown in FIG. 7I where the antenna unit AU1 is coupled to two receiver units RU1, RU2. The antenna unit RU1 typically also comprises an antenna ANT1 and a plurality of bandpass filters, BP1, BP2, BP3 . . . BPn. Typically, in each receiver unit, there will be two receiver sub-units RU1-1, RU 2-1 and RU 1-2, RU 2-2 for providing respective two downlink reception paths Rx1, Rx2 and two up link transmission paths Tx1, Tx2. The sub-units comprise transmit/receive switches Tx/Rx SW1, Tx/Rx SW2 and amplifiers AM1, AM2; AM3, AMm for the respective transmission and reception paths. FIG. 7I is a typical construction of an RFFE system with re-use of existing antenna units to allow 4×4 uplink and/or downlink MIMO for as many frequency bands as possible such as those shown in FIG. 7F discussed above.

### Antenna Units/Receiver Units of Near Side UE/Far Side UE

The typical construction of an RFFE system as in FIG. 7I is shown with more details for the Near side UE and the Far Side UE in FIG. 7J. In particular, FIG. 7J shows (in the dashed box) reception using the b46 2×2 downlink MIMO when using two receiver units RU3, RU4 and two antennas AMT5, AMT6. For the Wi-Fi frequency bands of 2.4 GHz/5 GHz, the receiver units RU3, RU4 comprise respective uplink and downlink transmission/reception paths Tx31, Tx32, Rx31, Rx32; Tx41, Tx42, Rx41, Rx42. The 2×2 downlink MIMO reception signals OB46-3, OB46-4 are generated by the reception paths Rx31, Rx41.

In the typical construction of FIG. 7J, RU3 and RU4 use a shared common Rx path and split Rx for concurrent DL support of both 5 GHz WiFi Rx and B46 Rx on 2 antennas. The typical RRFE in FIG. 7J enables separate strong filter attenuation for concurrent coexistence between adjacent bands b46=5 GHz WiFi and n79 (4.4-5 GHz) but significant IL is suffered to guarantee such performance on each antenna. As explained above, b46 is the same band definition/frequency range as 5 GHz WiFi, and is defined for shared license assisted access (LAA) and includes opportunistic alternating of Tx and concurrent Rx as shown with the common/split Rx paths. However, B46 is limited to 2×2 DL-MIMO because there are only 2 5 GHz WiFi antennas in the typical UE.

### 4×4 Downlink B46/NR-U Thru n79 Reception Path

FIG. 7K shows an embodiment of a UE RFFE which includes for the n79 band 4 Rx paths where 2 of these Rx paths are extended (re-used) to include b46. If there is Tx activity in the UE in either band, the n79 may have to fall back to 2×2 DL-MIMO, but does otherwise benefit from lower IL whilst the b46 4×4 DL-MIMO capability doubles the data rate and coverage for the b46 LAA downlink service.

In more detail, FIG. 7K shows a block diagram similar to that in FIG. 7J including the use of four receiver units RU1 to RU4 for realizing full b46 band 4×4 downlink-MIMO according to an embodiment. As already explained above, FIG. 7K shows the block diagram for extending two of the receiver paths of n79 to include 2 b46 reception paths and enable shared use. This is in particular realized with the modification of the receiver units RU1, RU2 already shown in FIG. 7J which provide two downlink reception paths Rx11, Rx12 for the n79 frequency band.

In this manner, the embodiment in FIG. 7K makes use of the fact that n79 already has 4 Rx paths which allows to share Rx use for n79 and B46 in 2 of the n79 Rx paths. 2 are in the lower receiver units RU3, RU4 and offer strong coexistence filtering with the 5 GHz WiFi band and define a passband 4.4-5 GHz, rejecting 5 GHz WiFi frequencies 5.15-5.85 GHz. The 2 upper receiver units RU1, RU2 are re-designed for shared use of both n79 and B46 with a wider passband 4.4 GHz-5.85 GHz that includes B46. If the UE is transmitting in either band, the extended Rx paths cannot be concurrently used-meaning that if there is B46 Tx or n79 Tx, then either band will have to fall back to 2×2 DL-MIMO. But if there is no Tx on in either band, as is the case for b46+n79 both receiving, or any time if there is no n79 or b46 Tx active, then full 4×4 DL-MIMO can be enabled for both bands, n79 as well as b46, and RATs concurrently.

As shown in FIG. 7K and in the method in FIG. 7M, the first receiver unit RU1 receives (step 7M1) a first RF signal from the first antenna unit ANT3. The first receiver unit RU1 comprises a first receive path Rx11, and this first receiver path Rx11 is adapted to process (step 7M2) the first RF signal (with a switch, a bandpass filter, an amplifier, and a splitter and further amplifiers (discussed below with reference to FIG. 7L)) to output (step 7M3) a first reception signal OB46-1 in the b46 frequency band and a second reception signal n79 in the n79 frequency band, which is, see FIG. 7F, adjacent to the b46 frequency band. The same construction is used in FIG. 7K and in the method of FIG. 7N for the second receiver unit RU2, which receives (step 7N1) a second RF signal from the antenna unit ANT4 and processes (step 7N2) this signal into two reception signals n79 and OB46-2 which are output (step 7N31) including one output signal as another output signal for the b46 downlink.

As in the existing B46 2×2 downlink MIMO system shown in FIG. 7J, also the B46 4×4 downlink MIMO according to FIG. 7K comprises the third and fourth receiver units RU3, RU4 which use one antenna ANT 5, ANT 6 commonly for the B46, Wi-Fi band and the 5 GHz Wi-Fi band using respective amplifier and splitter in the respective reception paths Rx31, Rx41. In this regard, as also shown with the method in FIG. 7O, the third receiver unit RU3 includes a first receive path Rx31 to process (step 702) a third RF signal received (step 701) from the antenna ANT5 and to output (step 703) the fifth reception signal OB46-3 in the first frequency band b46 and a sixth reception signal in the 5 GHz Wi-Fi band (a third frequency band).

Likewise, as also shown in the method of FIG. 7P, the fourth receiver unit RU4 receives (step 7P1) a fourth RF signal from the fourth antenna ANT6 and includes a receiver path Rx41 to process (step 7P2) the fourth RF signal and output (step 7P3) a seventh reception signal OB46-4 in the first frequency band (the b46 frequency band), and an eighth reception signal in the third frequency band (the 5 GHz Wi-Fi band).

Hence, in addition to the existing 2×2 downlink MIMO reception signals OB46-3, OB46-4 provided by the receiver units RU3, RU4 (FIG. 7J), the shared use of the n79 reception path Rx11, Rx21 provides two further downlink reception signals for the b46 frequency band without adding further reception paths or adding further antenna units (antennas). This re-the use of the existing n79 reception path (see FIG. 7J) provides two more downlink channels for the b46 frequency band, and hence enables full B46 4×4 downlink MIMO thru the n79 reception path.

According to an embodiment, the first receiver unit RU1 also includes a second reception path Rx12, configured to receive a fifth RF signal from the first antenna unit ANT3 where the second reception path Rx12 of the first receiver unit RU1 is adapted to process the fifth RF signal and output a ninth reception signal in a n77 (fourth) frequency band. Likewise, the second receiver unit RU2 includes a second reception path Rx22 configured to receive a sixth RF signal from the second antenna unit ANT4 (filtered by another bandpass filter), where the second receive path Rx22 of the second receiver unit RU2 is adapted to process the sixth RF signal received from the antenna unit ANT4 and output a tenth reception signal in the fourth frequency band n77.

Furthermore, according to an embodiment, the third receiver unit RU3 includes a second reception path Rx32 to receive a seventh RF signal from the third antenna unit ANT5, where the second reception path Rx32 of the third receiver unit RU3 is adapted to process this seventh RF signal and output an eleventh reception signal in a fifth frequency band. Likewise, the fourth receiver unit RU4 has a second reception pass Rx42 for receiving an eighth RF signal from the fourth antenna unit ANT6, where the second Rx path Rx42 of the fourth receiver unit RU4 is adapted to process the received RF signal from the antenna unit ANT6 and output a twelfth reception signal in the fifth frequency band.

As is indicated in the embodiment of FIG. 7J and FIG. 7K, the first frequency band can be the b46 band, the second frequency band can be the n79 band, the third frequency band can be the 5 GHz Wi-Fi band, the fourth frequency band can be the n77 band, and the fifth frequency band can be the 2.4 GHz Wi-Fi band.

Furthermore, according to another embodiment, the first and the third receiver units RU1, RU3 (and their antenna units) are located on the near side of the user equipment and the second and fourth receiver units RU2, RU4 (and their antenna units) are located on a far side of the user equipment, as shown in FIG. 7K.

### Embodiments of the Receiver Units Enabling Shared Use of Reception Paths

FIG. 7L shows a device, for example a mobile terminal or mobile device, where the antenna system includes a first to fourth antenna unit AN1-AN4 and a radio frequency, RF, front end, RFFE, system including a receiver system with the first to fourth receiver units RU1-RU 4 already generally shown in FIG. 7K. The receiver units RU1-RU4 include transmit and receive paths as already generally described with reference to FIG. 7K. Additionally, they comprise, according to embodiments, the following units/devices in the respective transmission and reception paths Rx11, Rx12; Rx21, Rx22; Rx31, Rx32, Tx31, Tx32; Rx41, Rx42, Tx41, Tx42. The units/devices output the first, third, fifth and seventh reception signals OB46-1, OB46-2, OB46-3, and OB46-4 for the B46 4×4 DL-MIMO reception. The b46 4×4 DL MIMO reception is also illustrated with the method steps in FIG. 7Q.

According to an embodiment, the first Rx path Rx11 of the first receiver unit RU1 comprises a bandpass filter BP11 adapted to filter (step 7Q1) the first RF signal received from the first antenna unit ANT1 with a passband including the first and second frequency bands (n79/b46).

According to another embodiment, the first Rx path Rx21 of the second receiver unit RU2 comprises a bandpass filter BP21 adapted to filter (step 7Q2) the second RF signal received form the second antenna unit ANT2 with a passband including the first and second frequency bands (n79/b46).

According to another embodiment, the first Rx path Rx11 of the first receiver unit RU1 further comprises a first amplifier AM11 configured to amplify (step 7Q3) the filtered first RF signal in a frequency range comprising the first and second frequency band (n79/b46).

According to another embodiment, the first Rx path Rx21 of the second receiver unit RU2 further comprises a first amplifier AM21 configured to amplify (step 7Q4) the filtered second RF signal in a frequency range comprising the first and second frequency band (n79/b46).

According to another embodiment, the first Rx path Rx11 of the first receiver unit RU1 further comprises a first splitter SP11 adapted to split (step 7Q5) the filtered and amplified first RF signal into the first and second reception signals in the b46 frequency band and the adjacent n79 frequency band. The splitter may be embodied as described for various power splitters in U.S. Pat. No. 10,944,377 B2 in the name of the present applicant. Typically, such a power splitter has an input and two outputs, as shown in FIG. 7L, and is configured to split the signal of a larger frequency bandwidth TBW (see FIG. 7F) into two output signals each of a different (and adjacent) smaller bandwidth band BW1 and BW2 (see FIG. 7F).

According to another embodiment, the first Rx path of the second receiver unit RU2 further comprises a second splitter SP21 adapted to split (step 7Q6) the filtered and amplified second RF signal into the third and fourth reception signals in the b46 frequency band and the adjacent n79 frequency band. The second splitter SP21 may be embodied as the first splitter SP11 described above.

According to another embodiment, the first Rx path Rx11 of the first receiver unit RU1 further comprises a second amplifier AM11-1 and a third amplifier AM11-2, the second amplifier AM11-1 amplifying the first reception signal in the first frequency range b46, and the third amplifier AM11-2 amplifying the second reception signal in the second frequency range n79 (step 7Q7). The third amplifier AM11-2 outputs the amplified first reception signal OB46-1 which is used as a first one of the four reception signals needed for b46 4×4 DL MIMO.

According to another embodiment, the first Rx path Rx21 of the second receiver unit RU2 further comprises a second amplifier AM21-2 and a third amplifier AM21-1, the second amplifier AM21-2 amplifying the third reception signal in the first frequency range b46, and the third amplifier AM21-1 amplifying the fourth reception signal in the second frequency range n79 (step 7Q8). The third amplifier AM11-2 outputs the amplified second reception signal OB46-2 which is used as a second one of the four reception signals needed for b46 4×4 DL MIMO.

According to another embodiment, the second Rx path Rx21 of the first reception unit RU1 comprises a bandpass filter BP12 configured to filter the fifth RF signal received from the first antenna unit AU1 with a passband including the fourth frequency band n77 and an amplifier AM12 adapted to amplify the filtered fifth RF signal and to output the amplified filtered fifth RF signal as the ninth reception signal in the fourth frequency band n77.

According to another embodiment, the second Rx path Rx22 of the second reception unit RU2 comprises a bandpass filter BP22 configured to filter the sixth RF signal received from the second antenna unit AU2 with a passband including the fourth frequency band n77 and an amplifier AM22 adapted to amplify the filtered sixth RF signal and output the amplified filtered sixth RF signal as the tenth reception signal in the fourth frequency band n77.

According to another embodiment, the first Rx path Rx31 of the third reception unit RU3 comprises an amplifier AM31 configured to amplify the third RF signal received from the third antenna unit AU3, a splitter SP31 adapted to split the amplified third RF signal into the fifth and sixth reception signals, and two amplifiers AM31-1, AM31-2 configured to respectively amplify the fifth and sixth reception signal in the 5 GHz WiFi and b46 frequency bands. The amplifier AM31-2 outputs the amplified fifth reception signal OB46-3 which is used as a third one of the four reception signals needed for b46 4×4 DL MIMO.

According to another embodiment, the first Rx path Rx Rx41 of the fourth reception unit RU4 comprises an amplifier AM41 configured to amplify the fourth RF signal received from the fourth antenna unit AU4, a splitter SP41 adapted to split the amplified fourth RF signal into the seventh and eighth reception signals, and two amplifiers AM41-1, AM41-2 configured to respectively amplify the seventh and eighth reception signal in the 5 GHz WiFi and b46 frequency bands. The amplifier AM41-1 outputs the amplified fifth reception signal OB46-4 which is used as a fourth one of the four reception signals needed for b46 4×4 DL MIMO.

According to still other embodiments, the third receiver unit RU3 and the fourth receiver unit RU4 also comprise a number of transmit/receive switches and transmission paths respectively for the 2.4 GHz Wi-Fi and 5 GHz Wi-Fi frequency bands. In this regard, the third receiver unit RU3 comprises a first transmit/receive switch SW31 which is connected to the receiver amplifier AM31, the transmit amplifier AM31′ and the antenna unit AU3. The transmit amplifier AM31′ is part of the transmit path Tx31 of the third receiver unit RU3. Likewise, there is a second transmit/receive switch SW32 which is connected to the reception amplifier AM32 of the reception path Rx32 and is connected to the transmit amplifier AM32′ of the second transmit path Tx32 for the 2.4 GHz Wi-Fi frequency band. Hence, using the transmit paths Tx32, Tx31 and the transmit amplifier AM31′, AM32′ and the transmit/receive switches SW31, SW32, 2 uplink signals in the 2.4 GHz Wi-Fi and the 5 GHz Wi-Fi frequency bands can be transmitted through the antenna unit AU3.

According to yet another embodiment, a similar configuration is used again for the 2.4 GHz Wi-Fi and 5 GHz Wi-Fi frequency bands in the reception unit RU4 for providing two transmit paths Tx41, Tx42 for 2 transmit signals to be provided to the antenna unit AU4. In this regard, according to still further embodiments, the fourth reception unit RU4 comprises a first transmit/receive switch SW41 which is connected to the receiver amplifier AM41, the transmit amplifier AM41′ and the antenna unit AU4. The transmit amplifier AM41′ is part of the transmit path Tx41 of the fourth receiver unit RU4. Likewise, there is a second transmit/receive switch SW42 which is connected to the reception amplifier AM42 of the reception path Rx42 and is connected to the transmit amplifier AM42′ of the second transmit path Tx42 for the 2.4 GHz Wi-Fi frequency band. Hence, using the transmit paths Tx42, Tx41 and the transmit amplifier AM41′, AM42′ and the transmit/receive switches SW41, SW42, 2 uplink signals in the 2.4 GHz Wi-Fi and the 5 GHz Wi-Fi frequency bands can be transmitted through the antenna unit AU4.

According to yet other embodiments, also the first and second reception units RU1, RU2 comprise transmit/receive switches SW11, SW12 and SW21, SW22, respectively. In FIG. 7L the switches SW11, SW12; SW21, SW22 are shown switched into a reception state providing reception signals from the antenna units AU1, AU2 to the respective reception paths Rx11, Rx21. The switches SW31, SW32 and SW41, SW42 are shown switched into a transmit state in which transmit signals from the transmit paths are provided to the antenna units AU3, AU4 in the respective frequency bands. When also the switches SW31, SW41 are switched to the reception state, full b46 4×4 DL MIMO is conducted along with 2.4 GHz 2×2 uplink MIMO. The shared or re-used n79 reception paths Rx11, Rx21 provide the b46 4×4 downlink MIMO reception with four reception signals without adding further reception paths or antenna units in addition to those shown in FIG. 7J for the different frequency bands.

### Balanced Amplifiers for Reduced Parasitic Interaction Between Antenna Elements in Phased Array MmWave Transmitters

As already described with regard to the RF system 200 shown in FIG. 5 or FIG. 6, a radio frequency (RF) front end (RFFE) system typically includes a (ultrahigh band, UHB) transmit and receive module 400 as shown in FIG. 7A. The module 400 typically includes a transmit (Tx) unit including a power amplifier 401 operating as a transmit amplifier to amplify a to be transmitted signal input at an input port UHB_TX and output an amplified to be transmitted signal to an antenna connected at the antenna port UHB_ANT. The module 400 also includes a receive (Rx) unit including a low noise amplifier (LNA) 402 operating as receive amplifier to receive a reception signal at the antenna port UHB_ANT and to output an amplifier reception signal to an output port UHB_RX. Furthermore, module 400 includes a transmit/receive switch 403, and optionally a UHB filter 404. This structure is in principle also present in all of the transmit and receive modules shown in FIG. 7J and FIG. 7K, cf. for example the NR PAID+SRS module, the MHB PAID module, or the LB PAID module.

The principle of building a transmit and receive system with several transmit and receive modules is also shown in FIG. 7G, FIG. 7H and FIG. 7I, cf. for example the two adjacent modules RU1-1/RU-2 comprising transmit units Tx1, Tx2 having a Tx path including bandpass filters BP1, BP3 and transmit amplifiers AM1, AM3, receive units Rx1, Rx2 having a Rx path including bandpass filters BP2, BPm and receive amplifiers AM2, AMm, and transmit/receive switches Tx/Rx SW1, SW2.

However, whilst all these examples of transmit and receive modules do not use a balanced amplifier structure for reducing parasitic signals, it should understood that the balanced amplifier structures described below can be used in any Tx unit of any transmit and receive module described in the present disclosure.

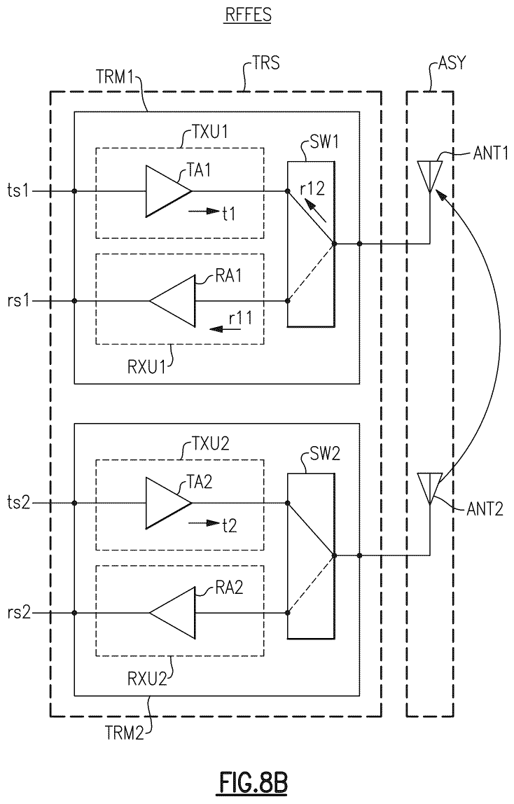

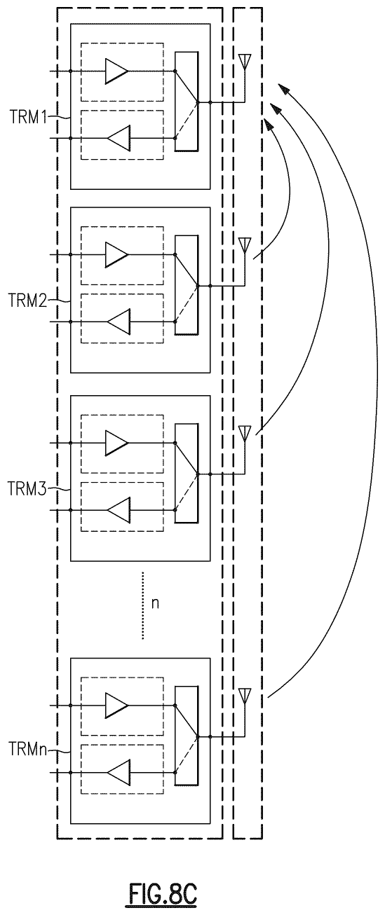

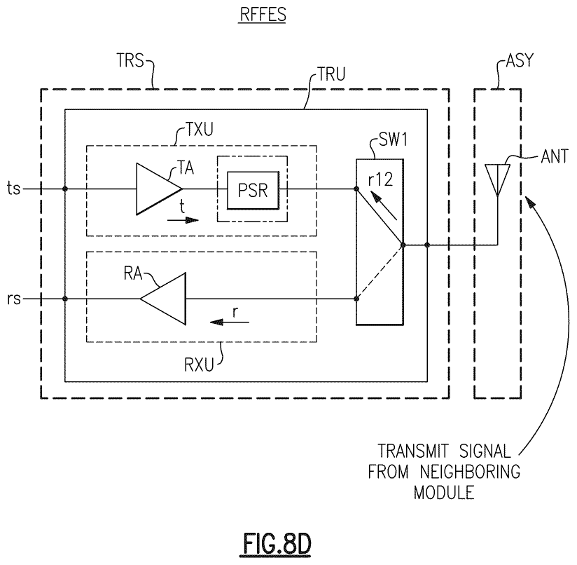

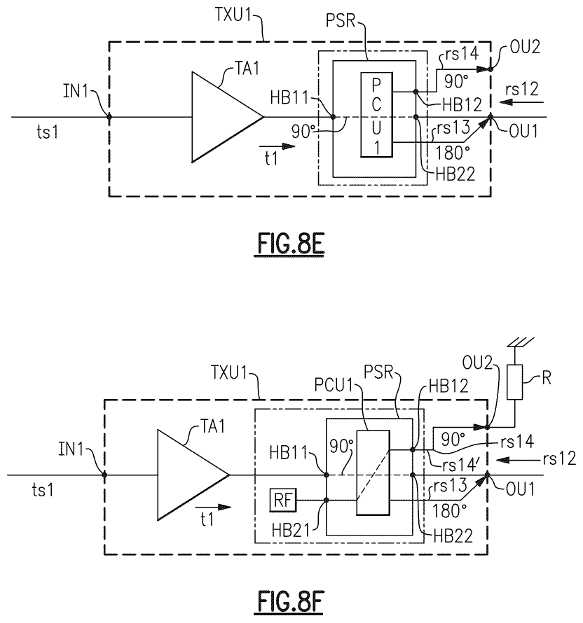

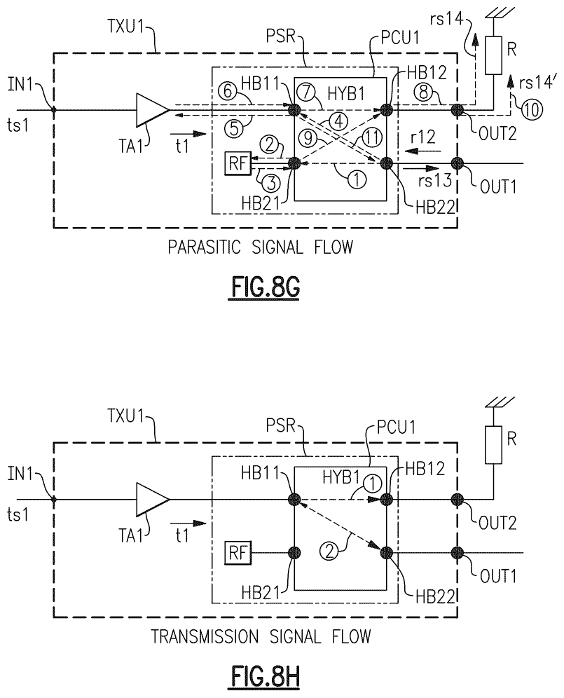

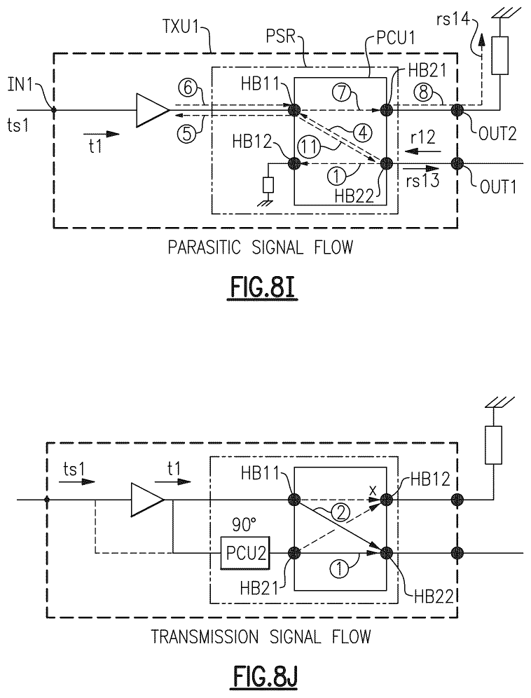

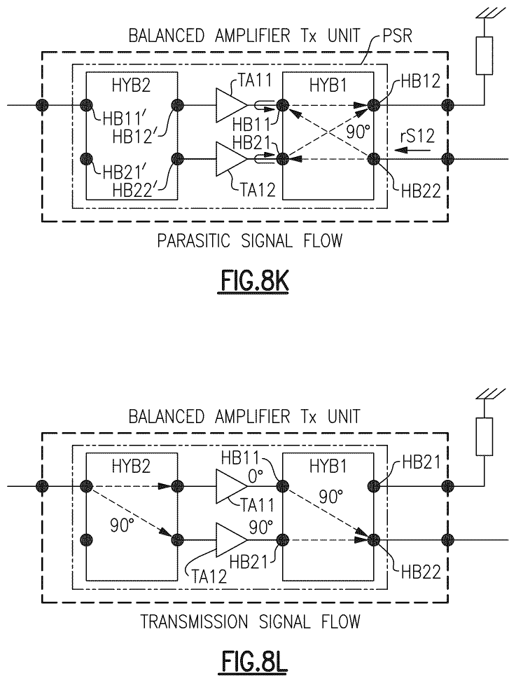

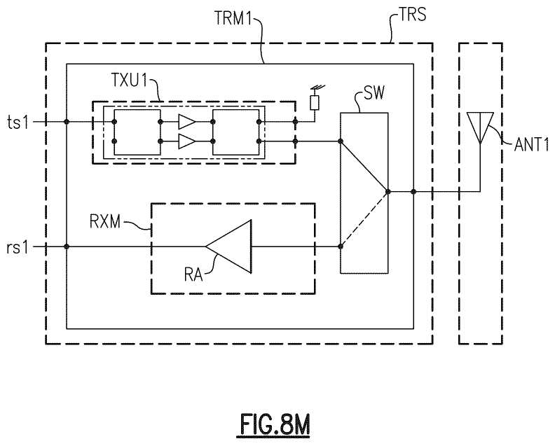

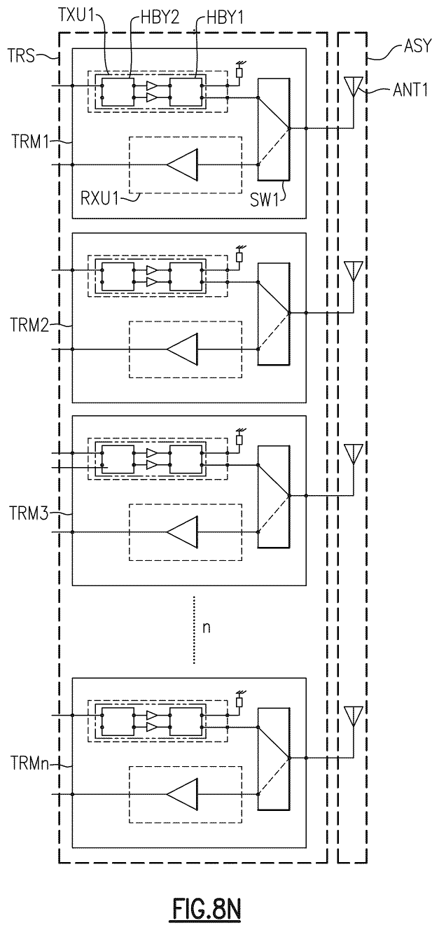

For the purpose of illustrating the need for removing parasitic signals coupled through an antenna system of a radio frequency (RF) front end (RFFE) system, RFFES, FIG. 8A and FIG. 8B again summarize the core elements of an RFFE system RFFES including an antenna system ASY and a transmit and receive (TR) system TRS.

RFFE System with a Single Transmit and Receive Module

According to an embodiment, the antenna system ASY in FIG. 8A and FIG. 8B typically comprises at least a first antenna ANT. The transmit and receive (TR) system TRS comprises at least a first transmit and receive (TR) module TRM. The TR module TRM comprises a transmit (TX) unit TXU, a receive (RX) unit RXU and a coupler (transmit and receive switch) SW which in FIG. 8A is illustrated in a position (shown with the full line) where the TX unit TXU is connected to the antenna ANT. In a second position of the coupler SW (shown with the dotted lines), the antenna ANT is connected to the receive unit RCU. The transmit unit TXU receives a to be transmitted signal ts which is amplified in the transmit amplifier TA of a transmit amplifier unit of the TX unit. The received signal r from the antenna ANT is amplified by a receive amplifier RA of a receive amplifier unit and an amplified received signal is output as the received signal rs.

Bandpass filters, as described above, may be used in the TX unit TXU and in the receive unit RCU to filter out parasitic signals in a different frequency band such that only the frequencies of the to be transmitted signal ts and of the received signal r are respectively transmitted to or received from the antenna ANT. Hence, as long as there are no further adjacent arranged (neighboring) transmit and receive modules TRM, the TRM module is self-contained and can be used in 2×2 MIMO uplink/downlink or 4×4 MIMO uplink/downlink communication systems, for example in the systems as shown in FIG. 7J, FIG. 7K and FIG. 7L.

RFFE System with Neighboring Transmit and Receive Modules

In a mobile terminal (user equipment) a plurality of TRM modules may have to be placed in close proximity due to space restrictions in the mobile terminal. As shown in FIG. 8B, typically the RFFE system includes a first and a second TR module TRM1, TRM2 each comprising transmit and receive amplifier units with transmit amplifiers TA1, TA2, RA1, RA2 provided in respective TX units TXU1, TXU2, RXU1, RXU2. Furthermore, each TR module TRM1, TMR2 may comprise its respective coupler (transmit and receive switch) SW1, SW2. Depending on the position of the switch in the coupler SW1, SW2, to be transmitted signals ts1, ts2 are transmitted to the respective antenna ANT1, ANT2, or received signals, e.g. r11, are amplified by the respective receive amplifier RA1, RA2 and are output as amplified receive signals rs1, rs2.

Whilst many of the TR modules TRM1, TRM2 may operate at different frequency bands, as explained above with reference to FIG. 7F, FIG. 7J and FIG. 7K, if for transmission/reception a phased array antenna is contained as antennas ANT1, ANT2 in the antenna system ASY, this phased array antenna may have to be driven by transmit signals in the same frequency band, possibly with different phases, in order to control for example directivity of the phased array antenna. This occurs in 2×2 as well as 4×4 uplink/downlink MIMO transmission/reception systems such as those discussed in FIG. 7F, FIG. 7J and FIG. 7K. In this case, even if bandpass filters are used in the TR modules TRM1, TRM2, still the TX unit TXU1 (or TXU2) may be impaired by back-injected transmission signals in the same frequency band from neighboring antenna elements, e.g. ANT2, as indicated with the arrow in FIG. 8B, when the coupler SW1 is switched to its transmit position.

If the coupler SW1 is switched to the receive position (the dotted line), such back-injected signals from a neighboring TR module TRM2 may also impair the receive unit RXU1. Therefore, although not shown with an arrow in FIG. 8B, signals transmitted from the antenna ANT1 will impair signals in the TX unit TXU2 as well as the RX unit RXU2 of the adjacent second TR module TRM2.

As shown in FIG. 8B, the first TX unit TXU1 transmits, with the coupler SW1 in the transmit position, a first RF transmission signal t1 to the first antenna ANT1 and when the coupler SW1 is in the received position, the RX unit RXU1 receives a first RF reception signal r11 from the first antenna ANT1. However, in the transmit position of the coupler SW2, a further transmission signal t2 of the second TX unit TXU2 of the second TR module TRM2 is transmitted from the second antenna ANT 2 and is also received at the first antenna ANT1 and is, therefore, back-injected into the TX unit TXU1 as a second RF reception signal r12.

Whilst FIG. 8B only shows possible impairments between two TR modules TRM1, TRM2, of course the impairments gets more severe if there are a plurality of (more than two) closely arranged TR modules TRM1, TRM2, TRM3 . . . . TRMn, as schematically shown in FIG. 8C. As illustrated with the plurality of arrows in FIG. 8C, many transmission signals even from further away TR modules back-inject their transmission signals as respective second RF reception signals into the TX unit of the first TR module TRM1.

Whilst FIG. 8C only shows the impairments caused in the first TR module TRM1, of course, all the other TR modules also impair each other with multiple couplings (not shown in FIG. 8C). This causes several impairment issues as follows.

### The Impairments Caused by Parasitic Signal Coupling

5G technologies include transmission of very high frequency radio signals to enable use of large available spectral bandwidths and beam forming in small form factors to direct more dedicated resources to individual users and increase data rates and reduce power consumption per bit. In particular, in typical phased array transmitters forming beams for uplink (UL) and downlink (DL), multiple antenna elements as shown in FIG. 8C are driven at varying amplitude and phase to construct coherent phase front transmission in a specific narrowed direction (directionality), with the benefits of antenna gain and less splatter of wasted energy in undesired directions. These phased arrays and the multiple active antenna elements must be calibrated in order to establish just the right amount of amplitude and phase from each antenna element in order to precisely position and adjust the beam which is quite a challenge in the small amount of available volume in the user equipment.

As shown in FIG. 8C, multiple arrays are typically placed in the handset in order to avoid blockage or limited scan angle/directionality from any one array and the precise beam direction and adjustment is at the core of establishing a high performance link. The more narrow the beam, the more sensitive impairments and off-angle errors become.

One of the most common UL impairments in the electrically small implementations required in the user equipment is the unexpected deviation from expected amplitude and phase that any one individual antenna element transmission suffers due to interference and finite isolation from the other neighboring antenna elements.

As illustrated in FIG. 8C, the back-injected signals of nearby antenna elements can cause clipping and/or reverse intermodulation due to the finite non-linearities of the power amplifiers used in the respective TR modules. They are challenged to become more non-linear as efficiency requirements increase.

The transmitter non-linearity can be corrected for forward non-linearity only using wide bandwidth DPD techniques. However, the back-injected (reverse) IMD and post-PA antenna coupling issues are not correctable even with DPD. In addition, complex time-consuming and expensive calibrations are required when it is required that individual transmission from each antenna element remains as consistent as possible, independent of the afore-mentioned variability due to neighboring elements because the sensitivity and performance as a function of amplitude/phase/modulation/etc. from each of the neighboring elements would become prohibitive to test for and correct using predictive models for the behavior.

### Typical Approach for Reducing Antenna Element Interactions

Attempts have been made in typical phased arrays (phased array transmitters) to minimize the antenna element interaction simply by a larger separation which is quite an expensive use of prohibited space in the user equipment.

Another typical approach is to design novel antenna designs to increase isolation to reduce near-field magnetic and electric moment overlaps (which were proven to be not as effective as desired).

Another approach is to incorporate expensive model development of the phased array including antenna coupling effects or to perform adaptive pre-distorting in order to correct the back-injection impairment (which is expensive in time and not available in low latency network applications and requires large digital current consumption).

Hence, the removal of parasitic signals (second RF reception signals e.g. r12 in FIG. 8C) from neighboring TR modules in typical phased arrays is requiring more space in the user equipment or is technically complicated and pre-distortion is not fast enough in low latency network applications.

Hereinafter, embodiments will be described which can be realized easily, allow the TR modules to be placed closely to each other (but do not require much space) and do not rely on complicated circuitry and do not pose any latency issues.

RFFE System with Parasitic Signal Removal

FIG. 8D shows a first embodiment of a RFFE system with parasitic signal removal in the TX unit of a TR module TRM. The TR module TRM in FIG. 8D includes a parasitic signal removal unit PSR. As shown in FIG. 8D, this parasitic signal removal unit PSR is specifically located in the transmit path that is in the TX unit TXU of the TR module TRM. The dashed box in the TX unit TXU indicates the positioning of the parasitic signal removal unit PSR after the transmit amplifier TA but in other embodiment described below as “balanced amplifier structures”, a part of the parasitic signal removal unit PSR may also be placed in front of the transmit amplifier TA.

The parasitic signal removal unit PSR specifically placed as shown in FIG. 8D is adapted to remove the second RF reception signals r12, that is the parasitic signal received at the at least one first antenna ANT1 and back-injected into the TX unit TXU of the first TR module TRM. As will be described below with more details in the embodiments of the parasitic signal removal unit PSR, the PSR is neither a complicated circuit nor does it require a large space and it also does not operate as a bandpass filter. However, it is configured to remove or at least mitigate the back-injection impairments from the neighboring transmit TR module or modules transmitting in the same frequency range (as indicated with the arrows in FIG. 8D).

### 180° and 90° Phase Shifting For Removing Parasitic Signal

As shown in the embodiment in FIG. 8E, the first TX unit TXU1 of the first TR module TRM1 includes a first output terminal OU1, a second output terminal OU2, and an input terminal IN1. The first output terminal OU1 is connected to the antenna ANT (ANT1) through the transmit and receive switch SW1 in the transmit position, as shown in FIG. 8D. The input terminal IN1 receives the to be transmitted signal ts1. A first input terminal HB11 of the PSR is connected to the output of the transmit amplifier TA1. The first output terminal HB12 of the PSR is connected to the second output terminal OU2 of the TX unit TXU1, and a second output terminal HB22 of the PSR is connected to the first output terminal OU1 of the TX unit TXU1.

As also shown in FIG. 8E, this embodiment of the PSR includes a first phase conversion unit PCU1 configured to convert the second RF reception signal rs12 (which is the parasitic signal) into a third RF reception signal rs13 and a fourth RF reception signal rs14. In particular, the first phase conversion unit PCU1 receives the second RF reception signal rs12 and, as indicated with “180°” on the right hand side of the PSR, converts the phase of this signal 180° so as to generate the third RF reception signal rs13 with a phase which is 180° shifted from that of the second RF reception signal rs12. That is, the third RF reception signal rs13 is the second RF reception signal rs12 the phase of which has been converted 180° but whose amplitude is the substantially the same as the second RF reception signal rs12.

Furthermore, the first phase conversion unit PCU1 also shifts the phase of the second reception signal rs12 90° and generates/outputs as the fourth RF reception signal rs14 the second RF reception signal r12 having its phase 90° shifted, as indicated with “90°” on the right hand side of the PSR in FIG. 8E, at the first output terminal HB12 and the second output OUT2.

Hence, the 90° phase shifted fourth RF reception signal rs14 is output to the second terminal OU2 of the TX unit TXU1, and the 180° phase shifted third RF reception signal rs13 is generated at (or present at) the first output terminal OU1 of the TX unit TXU1. As also indicated with the arrow in FIG. 8E, at the first output terminal OU1 of the TX unit TXU1 (which is connected to the coupler SW1) there is present the second RF reception signal rs12 (the parasitic signal) from the neighboring TR module and also the 180° phase shifted second RF reception signal rs12 indicated as the third RF reception signal rs13. Since on the first output terminal OU1 (also on the second output terminal HB22 of the PSR), two signals are present which have the same amplitude but 180° opposite phase with respect to each other, the signals rs12, rs13 cancel each other at the first output terminal OU1, thus removing the parasitic signal impairment on the transmit path of the TX unit TXU1.

The to be transmitted signal ts1 received at the input terminal IN1 of the TX unit TXU1 and respectively its amplified signal t1 is 90° phase shifted by the PCU1 between the first input terminal HB11 and the second output terminal HB22, as indicated with “90°” on the dashed line between these two terminals HB11 and HB22. In this manner, the transmission signal t1 can be transmitted through the output terminal OU1 to the antenna ANT1 whilst the signals rs12, rs13 essentially cancel each other at the second terminal HB22 and do not present an impairment due to the back-injection in the TX unit TXU1. Hence, the back-injection impairment is removed or at least mitigated.

In the embodiment in FIG. 8F, the second output terminal OU2 of the TX unit TXU1 of the TR module TRM1 is connected to ground, preferably through a resistor R, for example a 50 Ohm resistor. The first phase conversion unit PCU1 further comprises a reflection unit RF which is connected to the second input terminal HB21 of the PSR. In the embodiment in FIG. 8F, the PCU1 is configured to 90° phase shift the second reception signal rs12 into another fourth reception signal rs14′ by using the reflection unit RF as is indicated with the dashed line between the second input terminal HB21 and the first output terminal HB12 of the PSR. That is, the incoming second RF reception signal rs12 will be routed through the PSR, PCU1, will be reflected at the reflection unit RF, will be routed from HB21 to HB12, and will be output to the first output terminal HB12 of the PSR as second RF reception signal rs14′ having the same phase as the fourth reception signal rs14. Hence, the reflected second RF reception signal output as the other second fourth reception signal rs14′ will have the same phase (90° shifted from the second RF reception signal rs12) as the fourth RF reception signal rs14 and they are combined at the first output terminal HB12 and are dumped to ground acting as a sink. Hence, they will also not cause any impairment in the TX unit TXU1.

On the other hand, as in the embodiment in FIG. 8E, the signals rs13 and rs12 present (generated) at the second output HB22 cancel each other.

### Embodiment of the First Phase Shifting Unit Using a 90° Hybrid Coupler (Balun)

As indicated in the embodiment in FIG. 8E and FIG. 8F, for removing the parasitic signal rs12, the first phase conversion unit PCU1 functions to generates, from the parasitic second RF reception signal rs12, a 180° phase shifted signal rs13 (with substantially same amplitude as rs12) which cancels the parasitic signal rs12 at the second output terminal HB22 and two 90° shifted fourth reception signals rs14, rs14′ which are combined at the first output terminal HB12 and are then dumped to ground.

FIG. 8G and FIG. 8H show an embodiment of the first phase conversion unit PCU1 which realizes these functions by using a first 90° hybrid coupler denoted as HYB1. FIG. 8G shows the parasitic signal flow of the parasitic second RF reception signal rs12 and its cancellation by the third RF reception signal rs13 at the second output terminal HB22 of the first 90° coupler HYB1 as well as the generation of the two 90° shifted signals rs14, rs14′ which are combined at the first output terminal HB12 using the first 90° hybrid coupler HBY1 and the reflector unit RF.

FIG. 8H shows the transmission signal flow t1 of the to be transmitted signal ts1 and its outputting in a 90° shifted version to the first output terminal OU1 using the first 90° hybrid coupler HBY1.

A typical 90° hybrid coupler, also known as a quadrature hybrid or magic tee, is a passive device used in radio frequency (RF) communication systems. It is primarily used to combine or separate RF signals in a balanced manner. The 90° hybrid coupler consists of four ports labeled HB11, HB21, HB12, and HB22 in FIG. 8G and FIG. 8H. Ports HB11 and HB21 are the input ports, while ports HB12 and HB22 are the output ports. The 90° hybrid coupler allows for signal power division and phase shifting. Such hybrid couplers can be made of micro strip lines or can be Lange couplers.

The scattering matrix of such a 90° hybrid coupler causes, when two equal amplitude input signals with a phase difference of 90° are applied to ports HB11 (the 0° signal) and HB21 (the 90° signal), the 90° hybrid coupler to combine the signals at port HB22 with proper amplitude (−3 db) and both signals at 90° phase.

At the port HB12 which is the “isolation port” in this case, the signals cancel each other because the 90° input signal at HB21 is again 90° shifted when travelling to the port HB12 whilst the 0° input signal at HB11 is just routed to the port HB12 without a phase shift.

When a 90° input signal is applied to HB11 and a 0° input signal is applied to HB21, the situation is reversed, i.e. the port HB22 becomes the (extinction) isolation port and at the port HB12 two signals both having a 90° phase shift are generated.

When only a 0° signal is applied to the first input terminal HB11, it is divided into two equal amplitude signals at port HB12 (0°) with 0° phase shift and at port HB22 (90°) with a 90° phase difference.

A signal input to the port HB22 will be split into two signals with a 90° phase difference at ports HB12 (90°), HB21 (0°). That is, a signal input to one input port will general two signals with the a-3 db amplitude and a 90° phase difference at two output ports and two signals with same amplitude and a 90° phase shift input to two input ports will cause the generation of a combined signal of a 0° and a 180° signal at one output port and a 90° phase shifted version at the other output port. And this works also bidirectionally. That is, in the forward direction and in the backward direction, there is always one path to one output terminal in which the phase is not changed and another path to the other output in which the phase is 90° changed. These properties of a 90° hybrid phase coupler can be used to easily implement the necessary functionalities to be carried by the parasitic signal removal unit PSR or its respective first phase conversion unit PCU in the embodiments in FIG. 8E and FIG. 8F.

### Parasitic Signal Flow and Cancellation

FIG. 8G shows the parasitic signal flow and the cancellation of the parasitic signal rs12 received at the first output terminal OU1 of the TX unit TXU1. The encircled numbers designate a signal flow but do not indicate a specific sequence. They are just used to designate the respective signal flow.

In FIG. 8G, when the parasitic signal r12 is back-injected into the second output terminal HB22, a 0° signal \textcircled{1} is transferred to the second input terminal HB21 without phase shift. This signal is further forwarded \textcircled{2} to the reflector unit RF where it is back reflected \textcircled{3} into the second input terminal HB21. Therefore, the signal \textcircled{3} at HB21 is a 0° signal.

The parasitic signal r12 is 90° phase shifted and sent to the first input terminal HB11 in flow \textcircled{4}. This 90° phase shifted signal \textcircled{4} is transmitted (back-injected) to the transmit amplifier TA1 in flow \textcircled{5} where it is reflected back \textcircled{6} to the first input terminal HB11. Hence, the signal \textcircled{6} at the first input terminal HB11 has a 90° phase shift with regard to the signal \textcircled{3} present at the second input terminal HB21.

The 90° phase shifted signal \textcircled{6} will be forwarded \textcircled{7} to the first output terminal HB12 without a further phase shift. It is then output in flow \textcircled{8} from the first output terminal HB11 as the fourth RF reception signal rs14. It has a 90° phase shift with respect to the parasitic signal (second RF reception signal) r12.

The 0° signal \textcircled{3} present at the second input terminal HB21 receives a 90° shift on flow \textcircled{9} and is output as the signal rs14′ in flow \textcircled{10}. In fact, since both signals have the same 90° shift, they are just combined at the first output terminal HB21 as the first hybrid coupler HYB1 acts as a combiner for the signals \textcircled{3} and \textcircled{6}. Hence, the indication of the two signals rs14, rs14′ at the first output terminal HB12 does not mean that they are separately generated or present. It means that they are combined at the first output terminal since both have a 90° phase there.

Since at the first input terminal HB11 signal \textcircled{6} with a 90° phase shift is present and a 0° signal \textcircled{3} is present at the second input terminal HB21, the second output terminal HB22 will become the “isolation port” because in the signal flow \textcircled{11} a further phase shift of 90° is imparted such that the signal \textcircled{6} arrives at the second output port HB22 as the third RF reception signal rs13 with a 180° phase shift.

Hence, because a reflection takes place at the output of the first transmit amplifier TA1, the signals r12 and rs13 cancel each other at the isolation port HB22. In fact, the first 90° hybrid coupler generates the third 180° shifted RF reception signal rs13 at its second output terminal HB22 along with a 0° version of the second RF reception signal by the second RF reception signal having travelled through the first hybrid coupler HBY1 backwards, being reflected at the amplifier unit output, and travelling forwards again through the first 90° coupler, whilst at the same time the second RF reflection signal rs12 has travelled backwards from the second output terminal HB22 to the second input terminal HB21 and is reflected at the reflector unit RF and again travels forward from the second input terminal HB21 to the second output terminal HB22 without a phase shift.

Hence, due to the operation principle of the first 90° hybrid coupler, the second RF reception rs12 is present in the form of the backwards travelled and at the reflector unit RF reflected 0° signal \textcircled{1} at the second output terminal HB22 where it is cancelled by signal \textcircled{11} which represents the third RF reception signal rs13 having the 180° phase shift.

On the other hand, at the first output port HB21 the two combined 90° phase shifted signals rs14, rs14′ are dumped to ground. Hence, the energy of the parasitic signal is reduced and is cancelled on the transmission path for the transmission signal, as shown in FIG. 8G.

As shown in FIG. 8H which illustrates the transmission signal flow, the transmission signal t1 output by the transmit amplifier TA1 is input to the first input terminal HB11 and is 90° phase shifted in flow \textcircled{2} to the second output terminal HB22 connected to the first output terminal OUT1 of the transmit unit TXU1. Since in this operation no further 90° phase shifted signal is applied to the second port HB22, the first hybrid coupler HYB1 acts as a 90° splitter. Therefore, also a 0° signal \textcircled{1} is present at the first output terminal HB12 which is connected to ground via the second output terminal OUT2. Therefore, in FIG. 8H the transmission signal t1 is output to the antenna ANT1 with a 90° phase shift.

As will be understood from the flows and signals in FIG. 8G, whilst the reflector unit RF does not influence the signal flow for the transmission signal (signals \textcircled{1} and \textcircled{2} in FIG. 8H), the reflector unit RF does cause the generation of a second 90° phase shift signal \textcircled{9} at the second output terminal HB12 where it is combined with the signal \textcircled{10}. This further reduces the energy of the parasitic signal \textcircled{2} because the signal \textcircled{9}/(\textcircled{10}) combines with signal \textcircled{8} and the combined signal is dumped to ground through the resistor R.

However, as shown in another embodiment in FIG. 8I, the second input terminal HB12 can also be connected to ground, preferably through a resistor. Hence, in this case the signal rs14′ will not be generated and the 0° signal \textcircled{1} will be already dumped to ground without causing a further 90° phase shift signal at the first output HB12.

FIG. 8J shows another embodiment which can, in contrast to FIG. 8H, remove the signal flow \textcircled{1} of 0° of the transmission signal t1 between the first input terminal HB11 and the first output terminal HB12. The embodiment in FIG. 8J comprises a second phase conversion unit PCU2 which 90° phase shifts the transmission signal t1 or, as indicated with the dotted lines, the non-amplified to be transmitted signal ts1. In this case, a 90° phase shifted signal is applied to the second input terminal HB12 and a 0° (not phase shifted) signal is applied to the first input terminal HB21. Therefore, the first hybrid coupler HYB1 acts as a combiner such that the second output port HB22 has two 90° shifted signals from the flows \textcircled{2} and \textcircled{1} shown in FIG. 8J. However, in this case, the first output terminal HB21 acts as isolation port because here a 180° signal and a 0° signal, as indicated with the dotted lines in FIG. 8J, are present, such that these signals cancel each other at the first output terminal HB21.

Hence, there is no loss of power as in signal flow \textcircled{1} in FIG. 8H because no parts of the transmission signal t1 will occur on the first output terminal HB12. This cancellation is due to using the second phase conversion unit which is configured to 90° phase shift the to be transmitted signal received at the input terminal IN1.

TX Unit with Balanced Amplifier Structure

As is illustrated in the embodiment of FIG. 8K, the second phase correction unit PCU2 can be realized by a second hybrid coupler HYB2 and by splitting the transmit amplifier TA1 into two transmit amplifiers TA11, TA21 in a balanced amplifier structure.

As shown in FIG. 8K, the embodiment of the first phase conversion unit PCU1 is formed by a first input terminal HB11 of the first 90° hybrid coupler HBY1 connected to an output of the first transmit amplifier unit TA11, a second input terminal HB21 thereof connected to an output of the second transmit amplifier unit TA21, a first 0° output terminal HB12 thereof connected to the second output terminal, and a second 90° output terminal HB22 thereof connected to the first output terminal. The second phase conversion unit PCU2 is formed by the second 90° hybrid coupler HBY2 having an input terminal HB11′ connected to the input terminal of the Tx unit, a first 0° output terminal HB12′ connected to an input of the first transmit amplifier unit TA11, and a second 90° output terminal HB22′ connected to an input of the second transmit amplifier unit TA12.

In this case, the output of the second transmit amplifier TA12 acts as the reflector unit RF shown in FIG. 8G and the second hybrid coupler HYB2 acts as a 90° phase shifting device (essentially as the second phase conversion unit PCU2) to achieve two signals with 90° phase shift at the input terminals HB11, HB21 as shown in FIG. 8H. Since at the first input terminal HB11 a 0° signal is present and a 90° phase shifted signal is present on the second input terminal HB21, the first output terminal HB12 acts as the isolation port for the transmission signal whilst two 90° shifted signals are forwarded to the second output terminal HB22 where they are combined. This is shown with the transmission signal flows in FIG. 8L.

On the other hand, since the second 90° hybrid coupler HYB2 does not influence the parasitic signal flow (because the parasitic signal flow is reflected at the amplifiers), the signal flow for the parasitic signal is the same as in FIG. 8G. Therefore, as shown in the parasitic signal flow in FIG. 8K, when receiving the 0° signal rs12 back-injected into the TX unit, a 90° shifted and back reflected signal will be present on the first input terminal HB11 whilst a 0° signal will be present on the second input terminal HB21. Therefore, in this case the first output terminal HB12 acts as the isolation port for the parasitic signal rs12, whilst two 90° shifted signals are dumped to ground through the first output terminal HB12, as explained above with reference to FIG. 8G.

Thus, in FIG. 8K and FIG. 8L the first 90° hybrid coupler HYB1 is operated once in the forward direction by applying a 0° and a 90° transmission signal to the first input terminal HB11 and the second input terminal HB12, whilst due to the reflections at the output of the transmitters TA11, TA12, at the same time, the first 90° hybrid coupler HYB1 is operated also with a 90° shifted parasitic signal at the first input terminal HB11 and a 0° parasitic signal at the second input terminal HB21.

According to embodiments, the first and second transmit amplifiers TA11, TA12 may be power amplifiers (PA). According to one embodiment, the PA may be a Doherty power amplifier. According to another embodiment, the receive amplifier (RA in FIG. 8A and FIG. 8D) may be a low noise amplifier (LNA). According to one embodiment, the antenna system ASY may include a phased array antenna.

As can be seen from the embodiments in FIG. 8I to FIG. 8L, these embodiments employ a balanced amplifier architecture for each individual transmitter of the phased array antenna. This balanced amplification uses two transmit (TX) branches and two hybrid 90° baluns/couplers in order to establish phase coherence at the desired balun output while dumping undesired signal to a termination resistor at an isolation port. When undesired back-injected signals arrive at the output of such an architecture, the balance of the two transmit branches prevents gain and power variation, and the phase coherence properties result in cancellation of the reverse IMD (RIMD). This enables the transmitter (transmit and receive module) to have less variability and non-linear impairment typically suffered by a typical single-ended transmitter.

The implementation of 90° degree baluns using distributed Lange coupler structures is readily achievable at the higher frequencies of the mmWave transmit and receive module (transmitter), which are smaller and easier to implement in high performance for large relative % bandwidth and low loss. Additional embodiments can leverage Doherty amplification efficiency advantage by replacing each branch transmit power amplifier with a dual Doherty implementation within the balanced architecture—for significant efficiency advantage for larger peak to average waveform support and fixed supply voltage (average power tracking=APT) Tx architectures.

Hence, a balanced amplifier architecture for a phased array MmWave transmitter, comprising a first Tx path including a first transmit amplifier unit, a second Tx path including a second transmit amplifier unit, a first hybrid 90° balun coupler connected to the first Tx path, a second hybrid 90° balun coupler connected to the second Tx path, an isolation port connected to a termination resistor configured to dump undesired signals, and a desired balun output configured to provide phase coherence and cancelling reverse intermodulation distortion (RIMD) is advantageous over the typical transmit and receive module TRM shown in FIG. 8A.

According to one embodiment, FIG. 8M shows the balanced amplifier transmit unit TXU1 of FIG. 8K and FIG. 8L included in a transmit and receive module TRM1 which also comprises the receive amplifier unit RXU and the switch SW as well as the antenna ANT1.

In the embodiment in FIG. 8N, all the TR modules TRM1, TRM2, TRM3 . . . TRMn comprise a respective transmit unit TX as shown in FIG. 8K, FIG. 8L and FIG. 8M. Although not shown in FIG. 8N, of course any of the transmit units TXU1 shown in the embodiments in FIG. 8E to FIG. 8J, may also be used as a transmit unit in the transmit path of the TRM modules in FIG. 8M.

Furthermore, all the above described functionalities in FIG. 8A to FIG. 8N may be carried by the respective modules as method steps.

Receiver RX Unit with a Balanced Amplifier Structure

Furthermore, according to yet another embodiment, it is also advantageous that a structure using hybrid 90° couplers as in FIG. 8G to FIG. 8L may be used in the receiver unit RXU because the parasitic signal from a transmitting TX module TRM may also impact on the receive Rx path of a neighboring TRM when the transmit and receive switch SW is in its receive position as shown with the dotted lines in FIG. 8M. In this case, the receive amplifier RA is split into two balanced amplifiers as shown in the embodiment in FIG. 8K where instead of the transmission signal ts1, the reception signal r is received and where the second output terminal HB22 of the first hybrid 90° coupler HYB1 or respectively the first output OUT1 outputs the reception signal rs (the signals r and rs are shown in FIG. 8D).

In this case, the parasitic signal is back-injected from the reception signal side (output of the RXU unit). The same advantages as in FIG. 8K and FIG. 8L may be achieved.

### Further Embodiments/Applications

Any of the non-balanced amplifier structures or balanced amplifier structures in FIG. 8E to FIG. 8N can be used in the embodiments in one or more of FIG. 1 to FIG. 7Q.

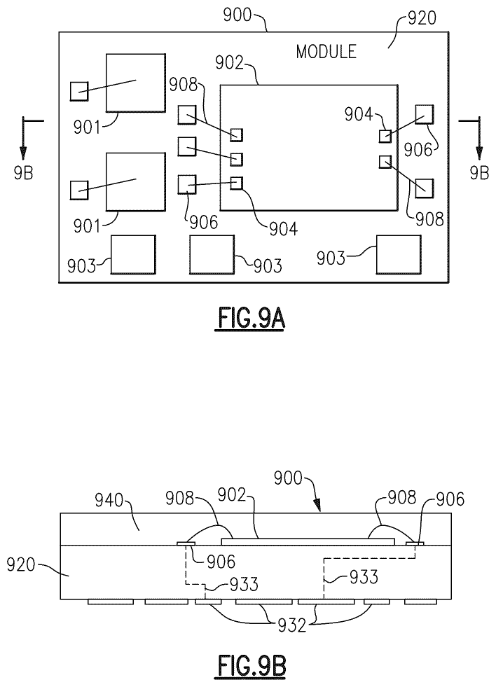

Furthermore, FIG. 9A is a schematic diagram of one embodiment of a packaged module 900. FIG. 9B is a schematic diagram of a cross-section of the packaged module 900 of FIG. 9A taken along the lines 9B-9B. The RFFE systems herein can include one or more packaged modules, such as the packaged module 900. Although the packaged module 900 of FIGS. 9A-9B illustrates one example implementation of a module suitable for use in a RFFE system, the teachings herein are applicable to modules implemented in other ways.

The packaged module 900 includes radio frequency components 901, a semiconductor die 902, surface mount devices 903, wirebonds 908, a package substrate 920, and encapsulation structure 940. The package substrate 920 includes pads 906 formed from conductors disposed therein. Additionally, the semiconductor die 902 includes pins or pads 904, and the wirebonds 908 are used to connect the pads 904 of the die 902 to the pads 906 of the package substrate 920.

As shown in FIG. 9B, the packaged module 900 is shown to include a plurality of contact pads 932 disposed on the side of the packaged module 900 opposite the side used to mount the semiconductor die 902. Any of the non-balanced amplifier structures or balanced amplifier structures in FIG. 8E to FIG. 8N can be provided in the packed module 900, for example on the die. Configuring the packaged module 900 in this manner can aid in connecting the packaged module 900 to a circuit board, such as a phone board of a wireless device. The example contact pads 932 can be configured to provide radio frequency signals, bias signals, and/or power (for example, a power supply voltage and ground) to the semiconductor die 902. As shown in FIG. 9B, the electrical connections between the contact pads 932 and the semiconductor die 902 can be facilitated by connections 933 through the package substrate 920. The connections 933 can represent electrical paths formed through the package substrate 920, such as connections associated with vias and conductors of a multilayer laminated package substrate.

In some embodiments, the packaged module 900 can also include one or more packaging structures to, for example, provide protection and/or facilitate handling. Such a packaging structure can include overmold or encapsulation structure 940 formed over the packaging substrate 920 and the components and die(s) disposed thereon.

It will be understood that although the packaged module 900 is described in the context of electrical connections based on wirebonds, one or more features of the present disclosure can also be implemented in other packaging configurations, including, for example, flip-chip configurations.

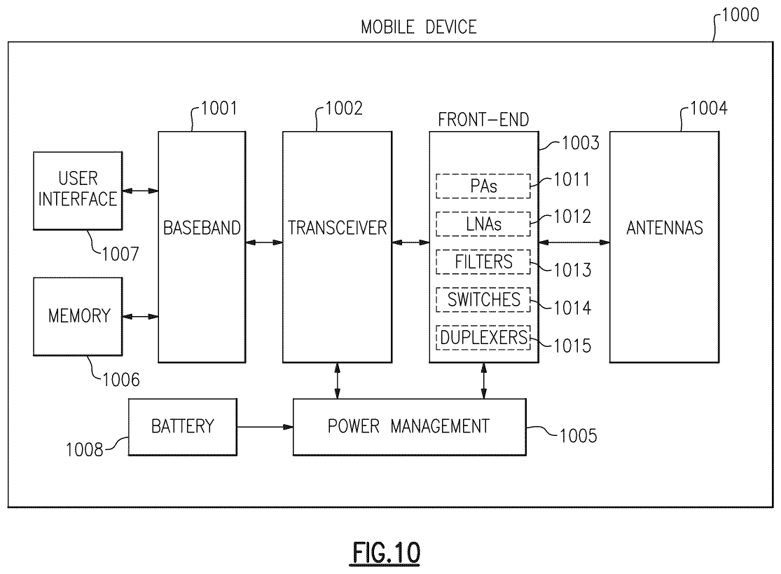

FIG. 10 is a schematic diagram of one embodiment of a mobile device 1000. The mobile device 1000 includes a baseband system 1001, a transceiver 1002, a front-end system 1003, antennas 1004, a power management system 1005, a memory 1006, a user interface 1007, and a battery 1008.

The mobile device 1000 can be used to communicate using a wide variety of communications technologies, including, but not limited to, 2G, 3G, 4G (including LTE, LTE-Advanced, and LTE-Advanced Pro), 5G NR, WLAN (for instance, Wi-Fi), WPAN (for instance, Bluetooth and ZigBee), WMAN (for instance, WiMax), and/or GPS technologies.

The transceiver 1002 generates RF signals for transmission and processes incoming RF signals received from the antennas 1004.

The front-end system 1003 aids in conditioning signals transmitted to and/or received from the antennas 1004. In the illustrated embodiment, the front-end system 903 includes power amplifiers (PAs) 1011, low noise amplifiers (LNAs) 1012, filters 1013, switches 1014, and duplexers 1015. However, other implementations are possible.

For example, the front-end system 1003 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 1000 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band or in different bands.

The antennas 1004 can include antennas used for a wide variety of types of communications. For example, the antennas 1004 can include antennas for transmitting and/or receiving signals associated with a wide variety of frequencies and communications standards.

In certain implementations, the antennas 1004 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 1000 can operate with beamforming in certain implementations. For example, the front-end system 1003 can include phase shifters having variable phase controlled by the transceiver 1002. Additionally, the phase shifters are controlled to provide beam formation and directivity for transmission and/or reception of signals using the antennas 1004. For example, in the context of signal transmission, the phases of the transmit signals provided to the antennas 1004 are controlled such that radiated signals from the antennas 1004 combine using constructive and destructive interference to generate an aggregate transmit signal exhibiting beam-like qualities with more signal strength propagating in a given direction. In the context of signal reception, the phases are controlled such that more signal energy is received when the signal is arriving to the antennas 904 from a particular direction. In certain implementations, the antennas 1004 include one or more arrays of antenna elements to enhance beamforming.

The baseband system 1001 is coupled to the user interface 1007 to facilitate processing of various user input and output (I/O), such as voice and data. The baseband system 1001 provides the transceiver 1002 with digital representations of transmit signals, which the transceiver 1002 processes to generate RF signals for transmission. The baseband system 1001 also processes digital representations of received signals provided by the transceiver 1002. As shown in FIG. 10, the baseband system 1001 may be coupled to the memory 1006 to facilitate operation of the mobile device 1000.

The memory 1006 can be used for a wide variety of purposes, such as storing data and/or instructions to facilitate the operation of the mobile device 1000 and/or to provide storage of user information.

The power management system 1005 provides a number of power management functions of the mobile device 1000. In certain implementations, the power management system 1005 includes a PA supply control circuit that controls the supply voltages of the power amplifiers 1011. For example, the power management system 1005 can be configured to change the supply voltage(s) provided to one or more of the power amplifiers 1011 to improve efficiency, such as power added efficiency (PAE).

As shown in FIG. 10, the power management system 1005 receives a battery voltage from the battery 1008. The battery 1008 can be any suitable battery for use in the mobile device 1000, including, for example, a lithium-ion battery.

The front-end system 1003 of FIG. 10 can be implemented in accordance with one or more features of the present disclosure. Although the mobile device 1000 illustrates one example of a RF communication device that can include a RFFE system implemented in accordance with the present disclosure, the teachings herein are applicable to a wide variety of RF electronics.

Aspects of this disclosure can be implemented in various electronic devices. Examples of the electronic devices can include, but are not limited to, consumer electronic products, parts of the consumer electronic products such as packaged radio frequency modules, radio frequency filter die, uplink wireless communication devices, wireless communication infrastructure, electronic test equipment, etc. Examples of the electronic devices can include, but are not limited to, a mobile phone such as a smart phone, a wearable computing device such as a smart watch or an ear piece or smart eyeglasses or virtual reality equipment, a telephone, a television, a computer monitor, a computer, a modem, a hand-held computer, a laptop computer, a tablet computer, a microwave, a refrigerator, a vehicular electronics system such as an automotive electronics system, a robot such as an industrial robot, an Internet of things device, a stereo system, a digital music player, a radio, IoT radios, a camera such as a digital camera, a portable memory chip, a home appliance such as a washer or a dryer, a peripheral device, a wrist watch, a clock, etc. Further, the electronic devices can include unfinished products.

Unless the context indicates otherwise, throughout the description and the claims, the words “comprise,” “comprising,” “include,” “including” and the like are to generally be construed in an inclusive sense, as opposed to an exclusive or exhaustive sense; that is to say, in the sense of “including, but not limited to.” Conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly coupled, or coupled by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively.

While certain embodiments have been described, these embodiments have been presented by way of example only, and are not intended to limit the scope of the disclosure. Indeed, the novel resonators, filters, multiplexer, devices, modules, wireless communication devices, apparatus, methods, and systems described herein may be embodied in a variety of other forms. Furthermore, various omissions, substitutions and changes in the form of the resonators, filters, multiplexer, devices, modules, wireless communication devices, apparatus, methods, and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and/or acts of the various embodiments described above can be combined to provide further embodiments. The accompanying claims and their equivalents are intended to cover such forms or modifications as would fall within the scope and spirit of the disclosure.

What is claimed is:

1. A radio frequency front end system, comprising:
an antenna system including at least one first antenna; and
a transmit and receive system including at least a first transmit and receive module having a transmit unit configured to transmit a first radio frequency transmission signal to the at least one first antenna, a receive unit configured to receive a first radio frequency reception signal from the at least one first antenna and a parasitic signal removal unit configured to remove a second radio frequency reception signal received at the at least one first antenna and back-injected into the transmit unit of the first transmit and receive module.

2. The radio frequency front end system of claim 1 wherein the transmit unit includes a first output terminal, a second output terminal, and an input terminal, the first output terminal being connected to the at least one first antenna and the input terminal adapted to receive a to be transmitted signal.

3. The radio frequency front end system of claim 2 wherein the parasitic signal removal unit is arranged in the transmit unit of the first transmit and receive module and includes a first phase conversion unit configured to convert the second radio frequency reception signal into a third radio frequency reception signal and a fourth radio frequency reception signal.

4. The radio frequency front end system of claim 3 wherein the first phase conversion unit is configured to output as the third radio frequency reception signal the second radio frequency reception signal with a phase 180° shifted from that of the second radio frequency reception signal, and to output as the fourth radio frequency reception signal the second radio frequency reception signal with a phase 90° shifted from that of the second radio frequency reception signal.

5. The radio frequency front end system of claim 4 wherein the parasitic signal removal unit is configured to output the second radio frequency reception signal and the third radio frequency reception signal to the first output terminal of the transmit unit of the first transmit and receive module, the second and third radio frequency signals cancelling each other at the first output terminal.

6. The radio frequency front end system of claim 4 wherein the parasitic signal removal unit is further configured to output the fourth radio frequency reception signal to the second output terminal of the transmit unit of the first transmit and receive module.

7. The radio frequency front end system of claim 2 wherein the second output terminal of the transmit unit of the first transmit and receive module is connected to ground.

8. The radio frequency front end system of claim 2 wherein the first transmit and receive module further includes a transmit/receive switch having a first, second and third switch terminal, the first switch terminal being connected to the first antenna, the second switch terminal being connected to the first output terminal of the transmit unit, and the third switch terminal being connected to the receive unit of the first transmit and receive module.

9. The radio frequency front end system of claim 2 wherein the transmit unit of the first transmit and receive module further includes a second phase conversion unit configured to 90° phase shift the to be transmitted signal received at the input terminal, a first transmit path and a second transmit path, the first transmit path including a first transmit amplifier unit configured to amplify the to be transmitted signal, and the second transmit path including a second transmit amplifier unit configured to amplify the 90° phase shifted to be transmitted signal.

10. The radio frequency front end system of claim 10 wherein the first phase conversion unit is formed by a first input terminal of a first 90° hybrid coupler connected to an output of the first transmit amplifier unit, a second input terminal thereof connected to an output of the second transmit amplifier unit, a first 0° output terminal thereof connected to the second output terminal, and a second 90° output terminal thereof connected to the first output terminal.

11. The radio frequency front end system of claim 10 wherein the second phase conversion unit is formed by a second 90° hybrid coupler having an input terminal connected to the input terminal of the transmit unit, a first 0° output terminal connected to an input of the first transmit amplifier unit, and a second 90° output terminal connected to an input of the second transmit amplifier unit.

12. The radio frequency front end system of claim 10 wherein the receive unit includes a receive path having a receive amplifier.

13. The radio frequency front end system of claim 13 wherein the first transmit amplifier unit and the second transmit amplifier form a Doherty power amplifier.

14. A radio frequency front end system, comprising:
an antenna system including at least one first antenna; and
a transmit and receive system including at least a first transmit and receive module having a transmit unit including a first output terminal being connected to the at least one first antenna, a second output terminal connected to ground, and an input terminal adapted to receive a to be transmitted signal, a first 90° hybrid coupler, two transmit amplifier units, and a second hybrid 90° coupler,
a first input terminal of the first 90° hybrid coupler connected to an output of the first transmit amplifier unit, a second input terminal thereof connected to an output of the second transmit amplifier unit, a first 0° output terminal thereof connected to the second output terminal, and a second 90° output terminal thereof connected to the first output terminal, and
the second 90° hybrid coupler having an input terminal connected to the input terminal of the transmit unit, a first 0° output terminal connected to an input of the first transmit amplifier unit, and a second 90° output terminal connected to an input of the second transmit amplifier unit.

15. The radio frequency front end system of claim 19 wherein the first transmit and receive module includes a resistor connected between the second output terminal of the transmit unit of the first module and ground.

16. The radio frequency front end system of claim 19 wherein the first transmit and receive module further includes a transmit/receive switch having a first, second and third switch terminal, the first switch terminal being connected to the at least one first antenna, the second switch terminal being connected to the first output terminal of the transmit unit, and the third switch terminal being connected to the receive unit of the first transmit and receive module.

17. The radio frequency front end system of claim 19 wherein the receive unit includes an receive path, the receive path including a receive amplifier.

18. The radio frequency front end system of claim 19 wherein the first and second transmit amplifier are power amplifiers form a Doherty power amplifier.

19. The radio frequency front end system of claim 19 wherein the antenna system includes a phased array antenna.

20. A balanced amplifier architecture for a phased array MmWave transmitter, comprising:
a first transmit path including a first transmit amplifier unit;
a second transmit path including a second transmit amplifier unit;
a first hybrid 90° balun coupler connected to the first transmit path;
a second hybrid 90° balun coupler connected to the second transmit path;
an isolation port connected to a termination resistor configured to dump undesired signals; and
a desired balun output configured to provide phase coherence and cancelling reverse intermodulation distortion.
